(19) United States
(12) Patent Application Publication
(10) Pub. No.: US 2025/0211986 A1
(43) Pub. Date: Jun. 26, 2025

(54) Slice Security

(71) Applicant: Ofinno, LLC, Reston, VA (US)

(72) Inventors: Henrik Andreas Normann, Münich (DE); SungDuck Chun, Fairfax, VA (US); Esmael Hejazi Dinan, McLean, VA (US); Peyman Talebi Fard, Vienna, VA (US); Taehun Kim, Fairfax, VA (US); Kyungmin Park, Vienna, VA (US); Jian Xu, McLean, VA (US); Oanyong Lee, Seoul (KR)

(21) Appl. No.: 18/988,341

(22) Filed: Dec. 19, 2024

Related U.S. Application Data
(60) Provisional application No. 63/612,756, filed on Dec. 20, 2023.

(51) Int. Cl. H04W 12/06; H04W 12/72; H04W 60/04

(52) U.S. Cl. CPC H04W 12/06; H04W 12/72; H04W 60/04

(57) ABSTRACT

A wireless device sends, to a base station associated with an evolved packet core (EPC), a request message requesting a packet data network (PDN) connectivity. The request message comprises an indication of support for network slice specific authentication and authorization (NSSAA) over the EPC, and the PDN connectivity is associated with a network slice of a 5G system (5GS).

### CROSS-REFERENCE TO RELATED APPLICATIONS

This application claims the benefit of U.S. Provisional Application No. 63/612,756, filed Dec. 20, 2023, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

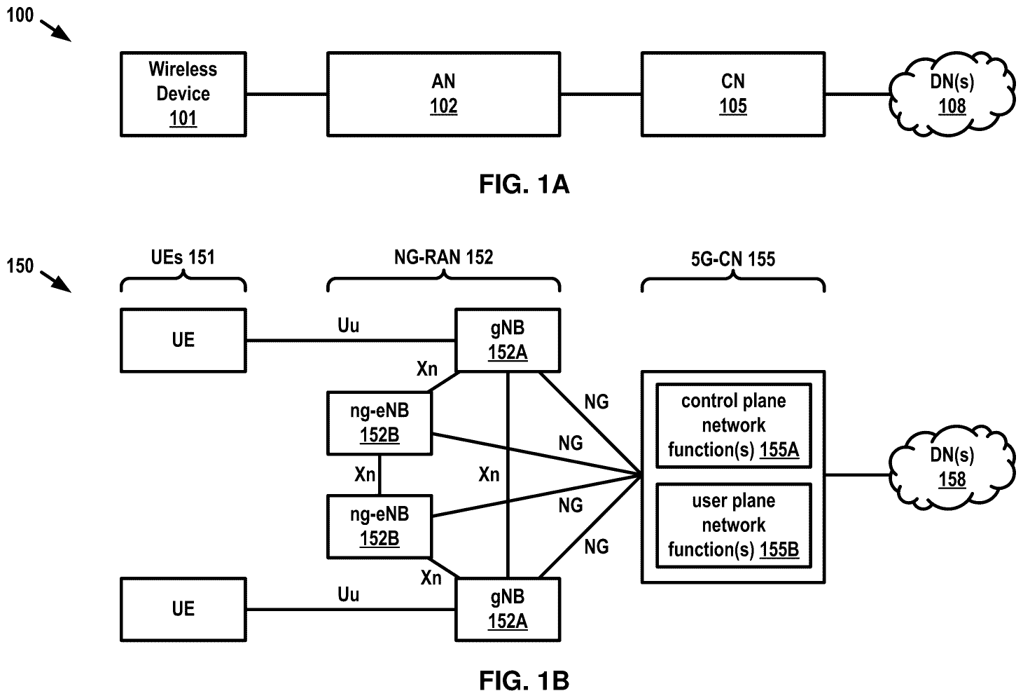

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

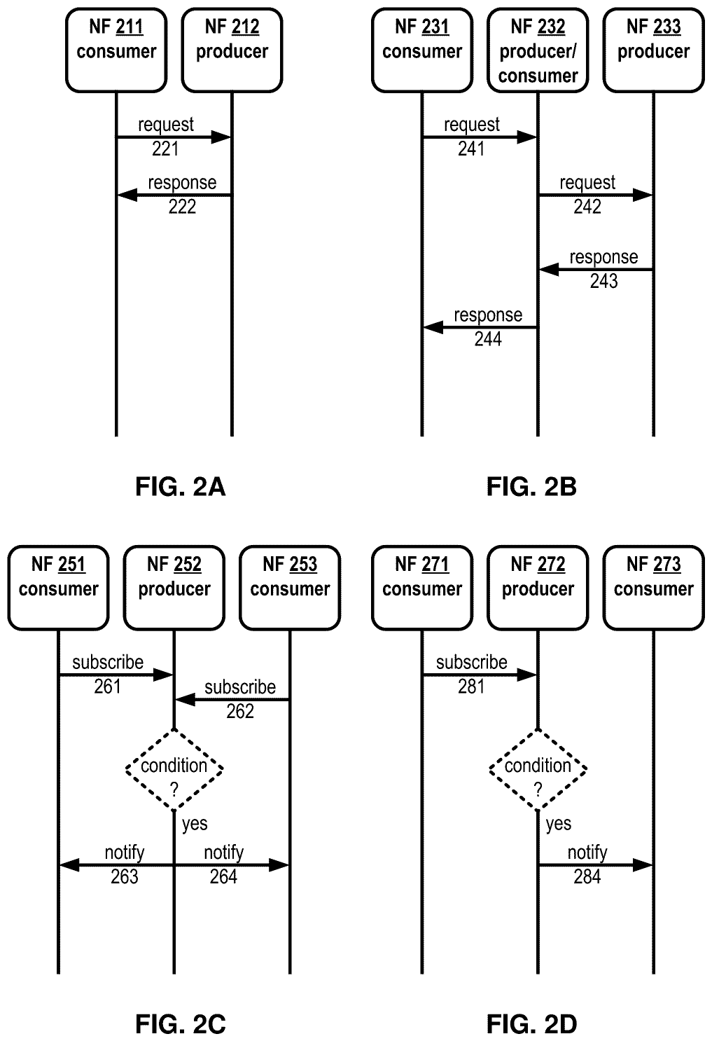

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

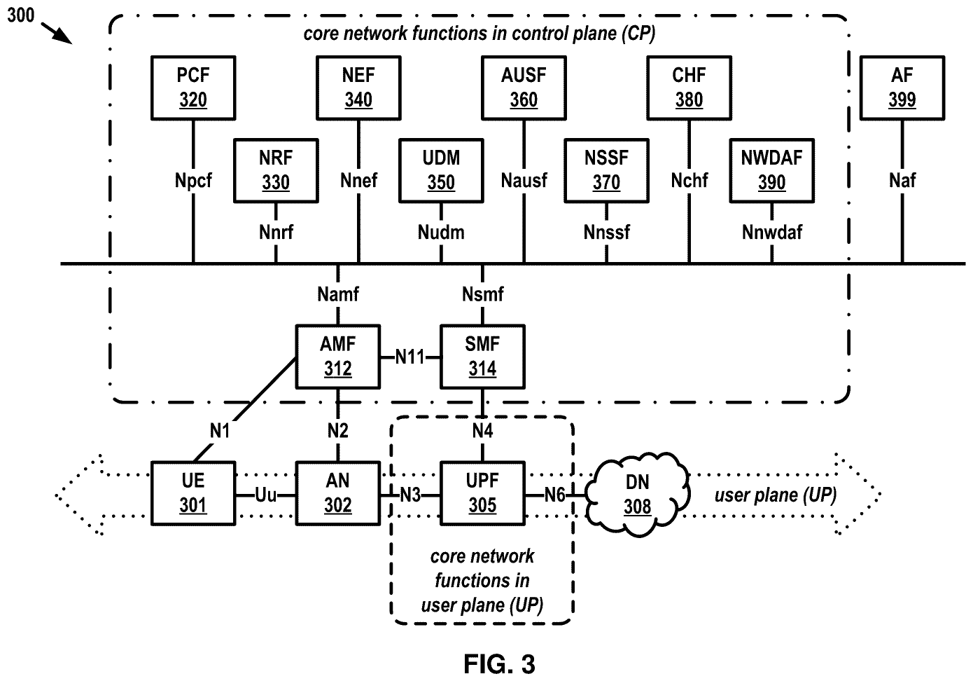

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

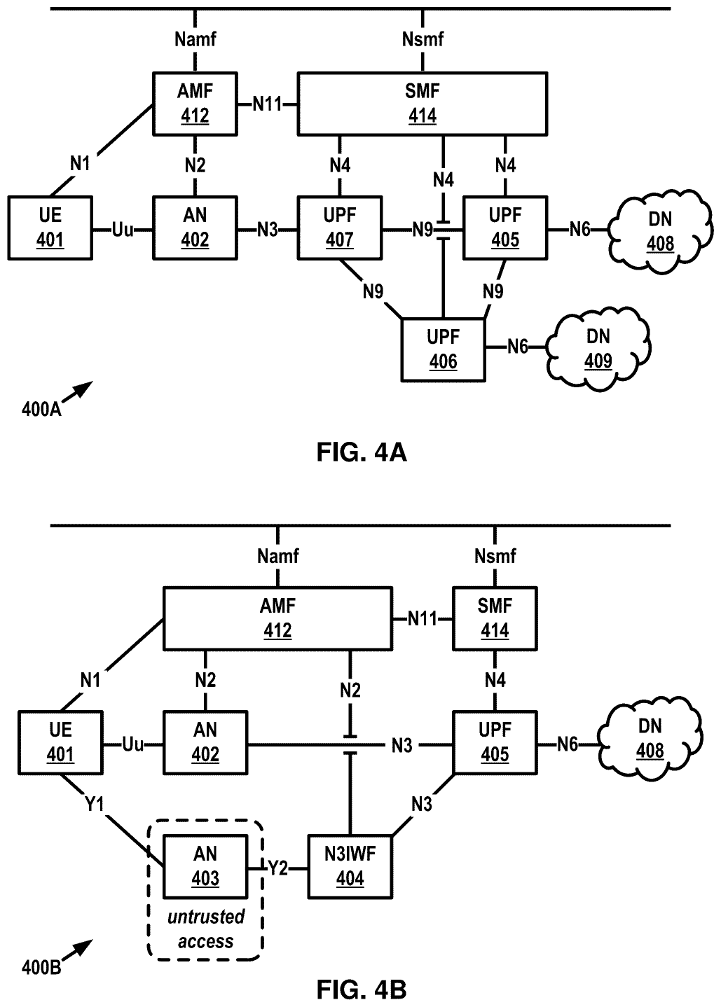

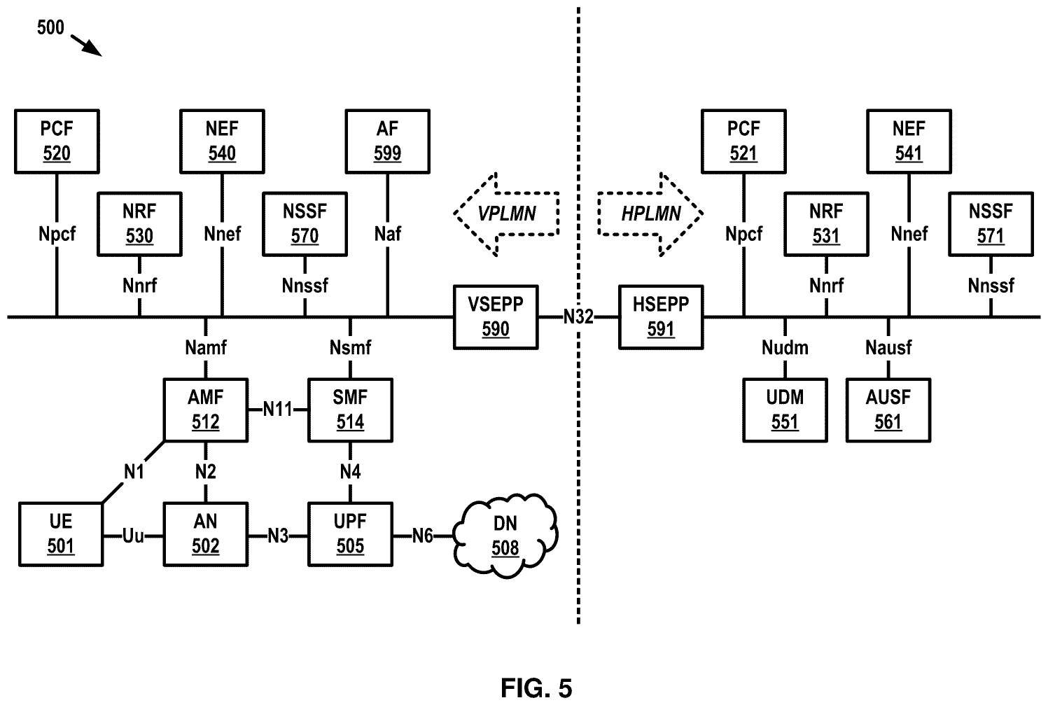

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

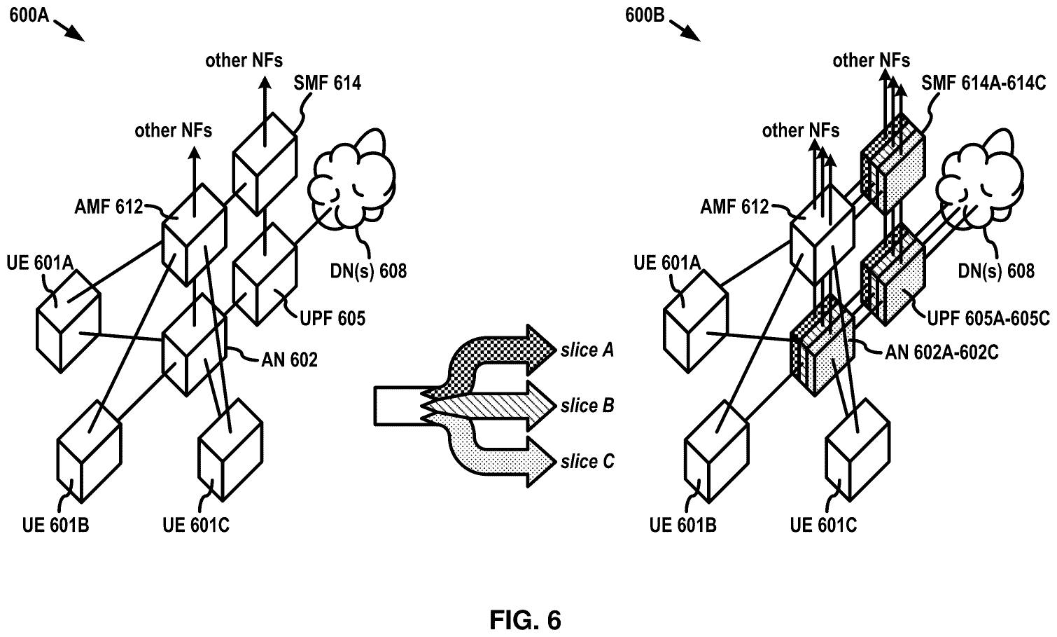

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

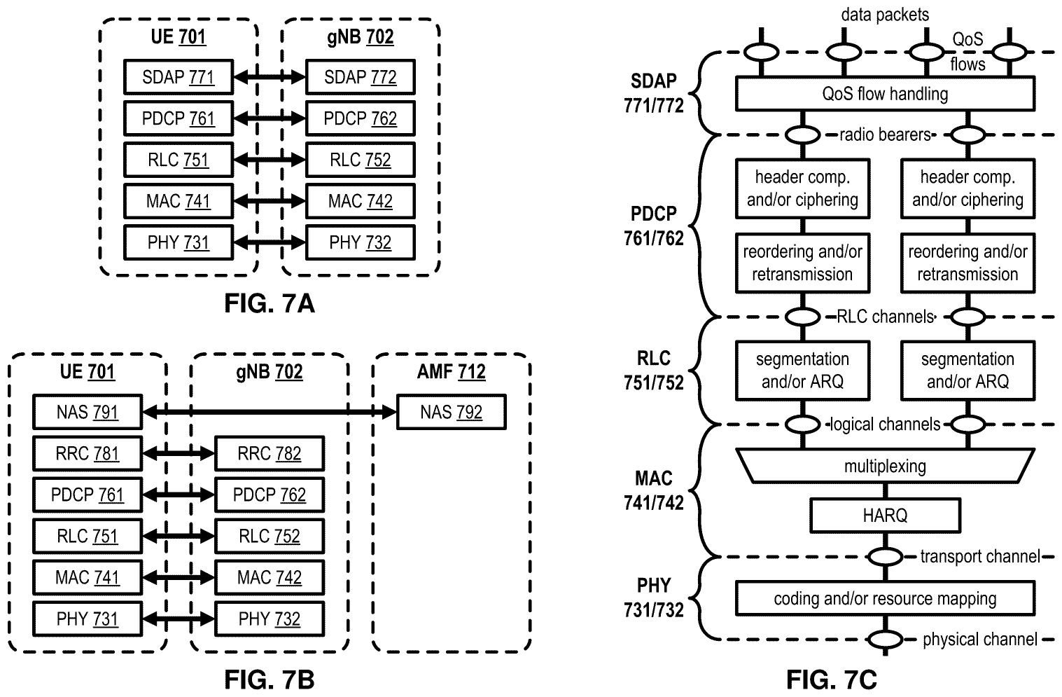

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

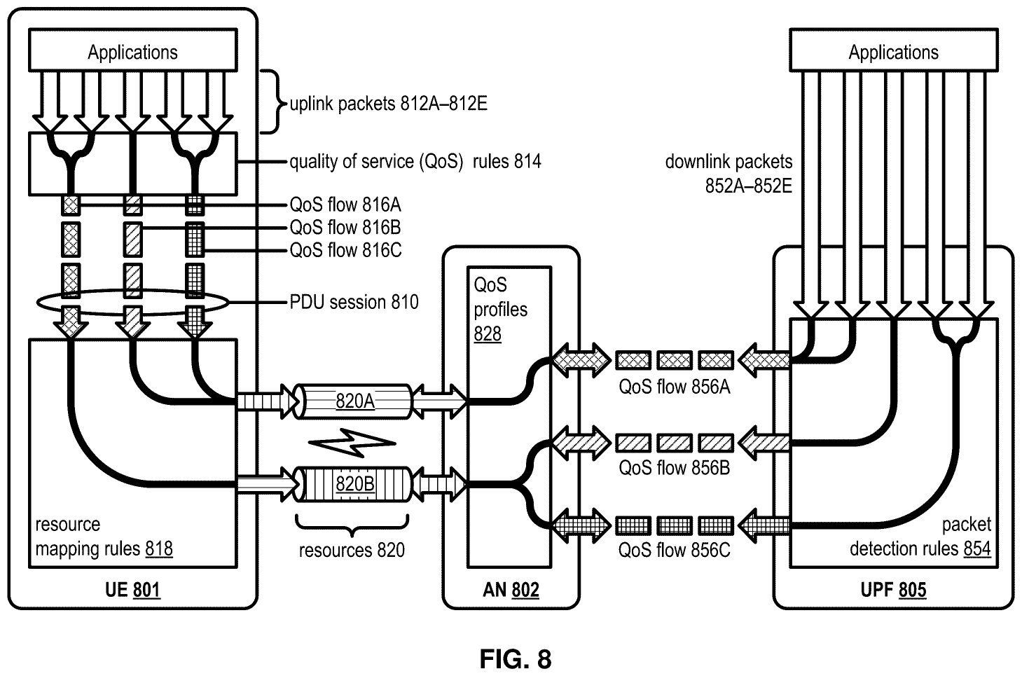

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

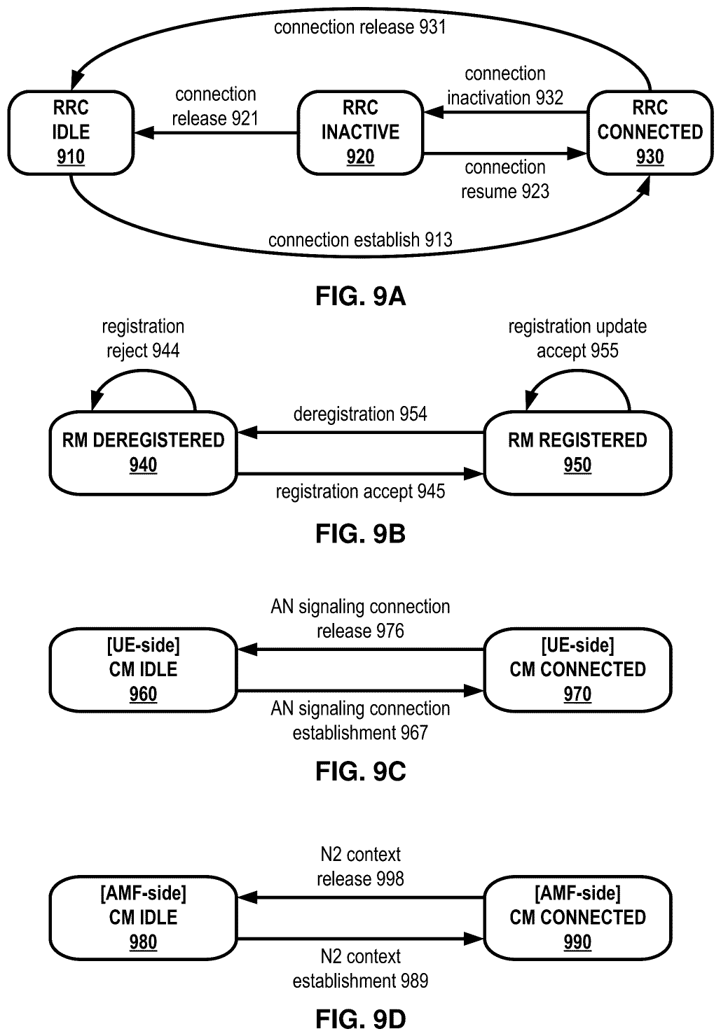

FIGS. 9A-9D illustrate example states and state transitions of a wireless device (e.g., a UE). At any given time, the wireless device may have a radio resource control (RRC) state, a registration management (RM) state, and a connection management (CM) state

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

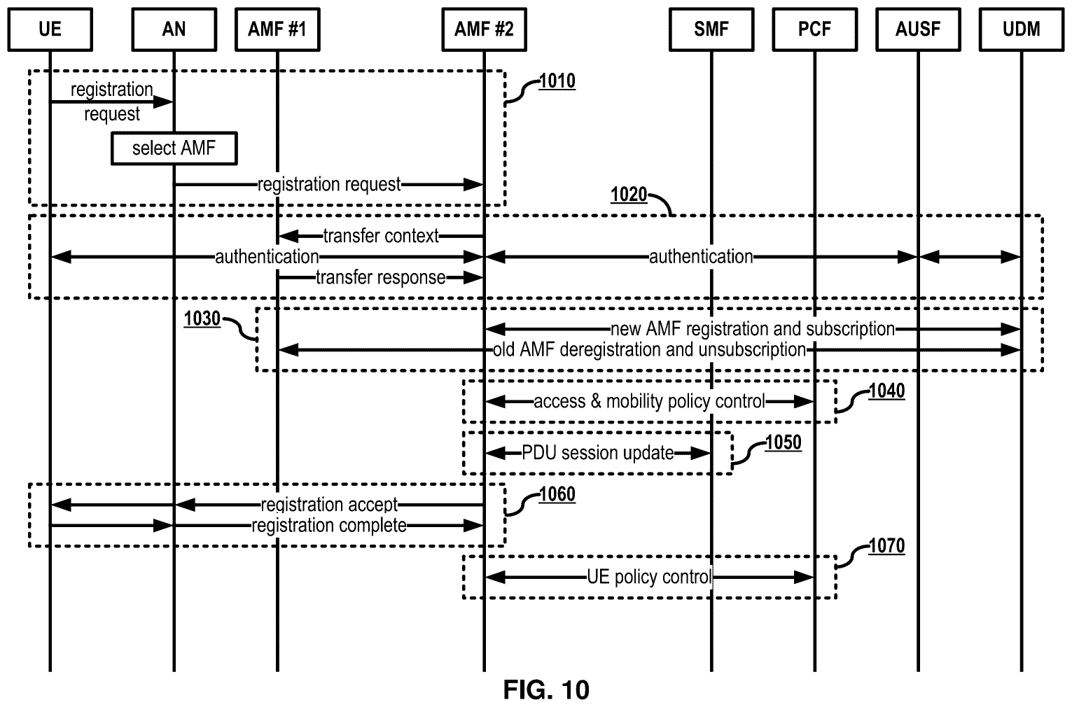

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

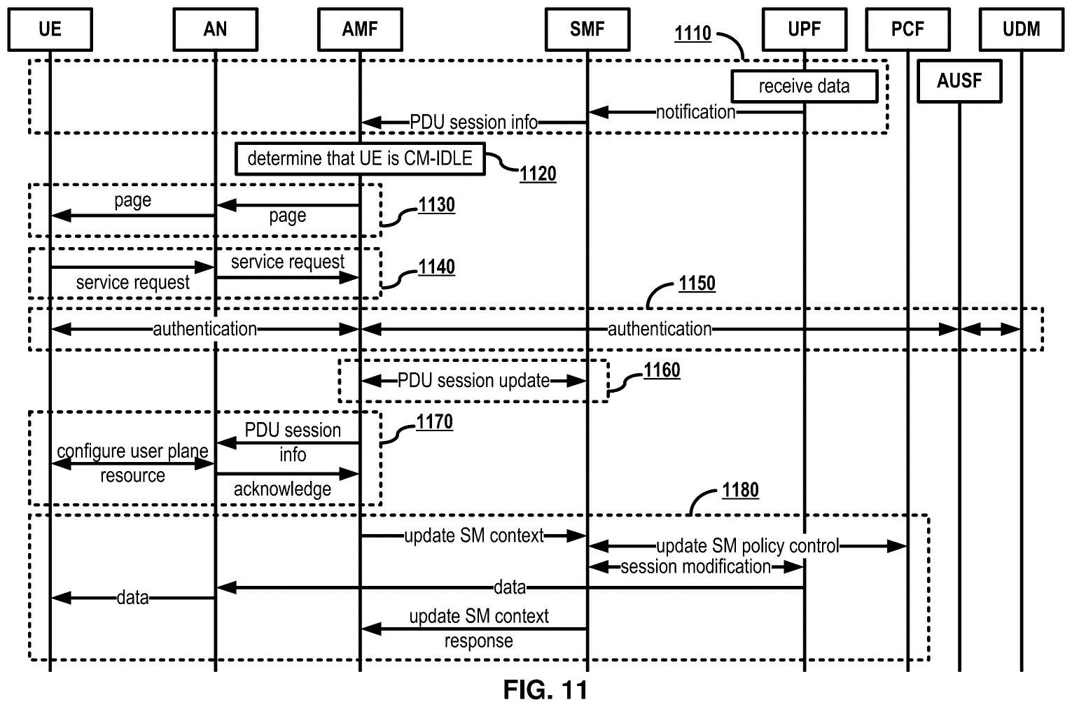

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

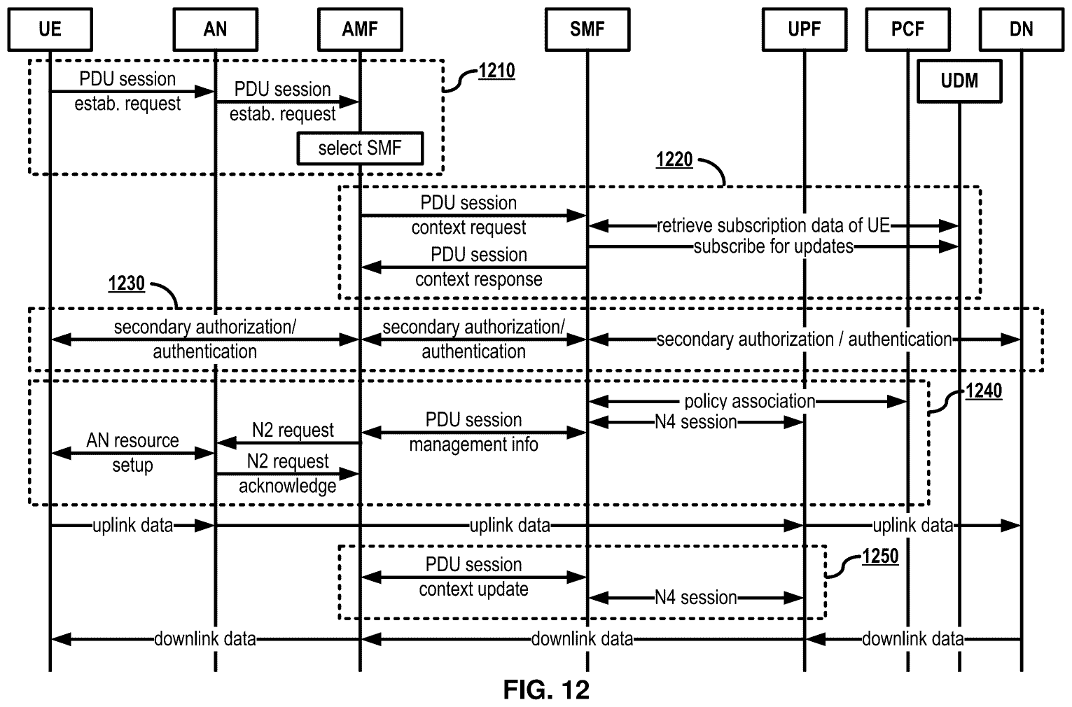

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPV4, IPV6, or dual stack IPV4/IPV6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

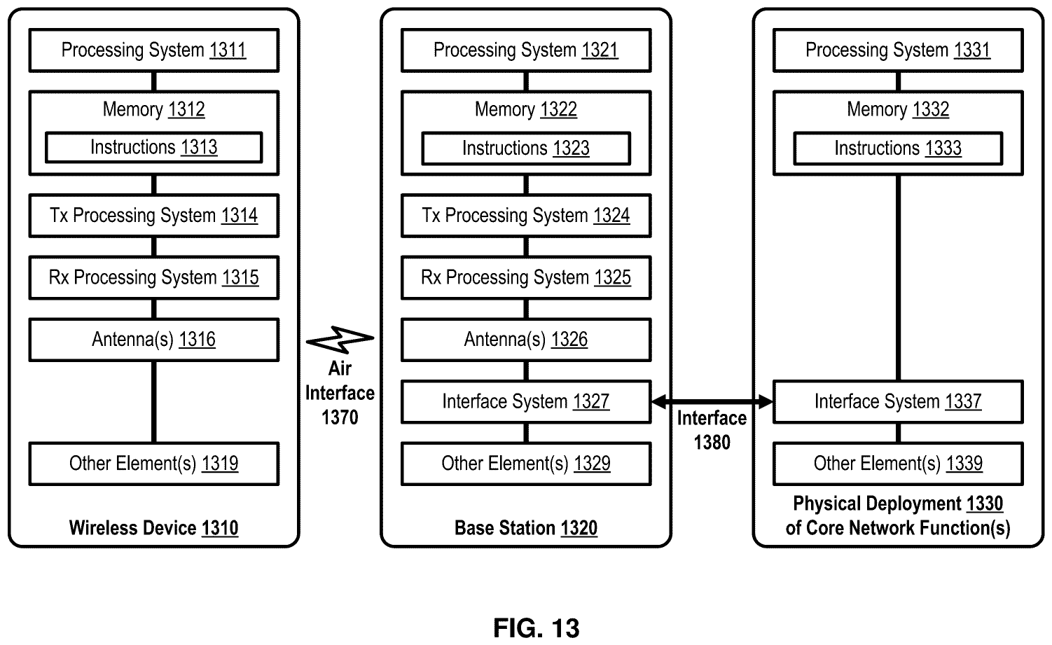

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

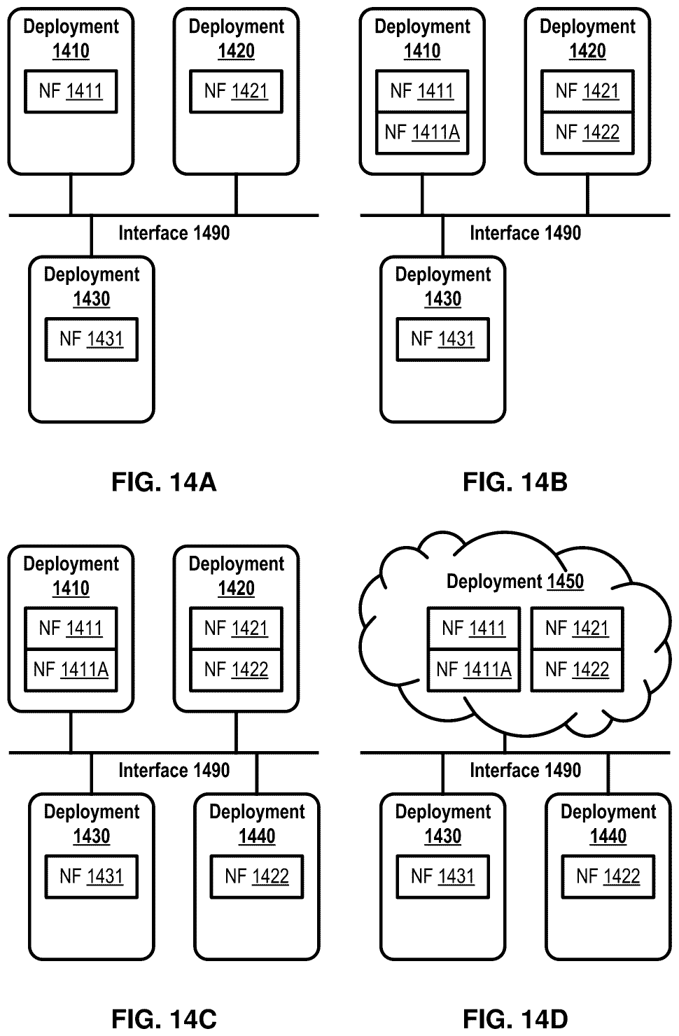

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

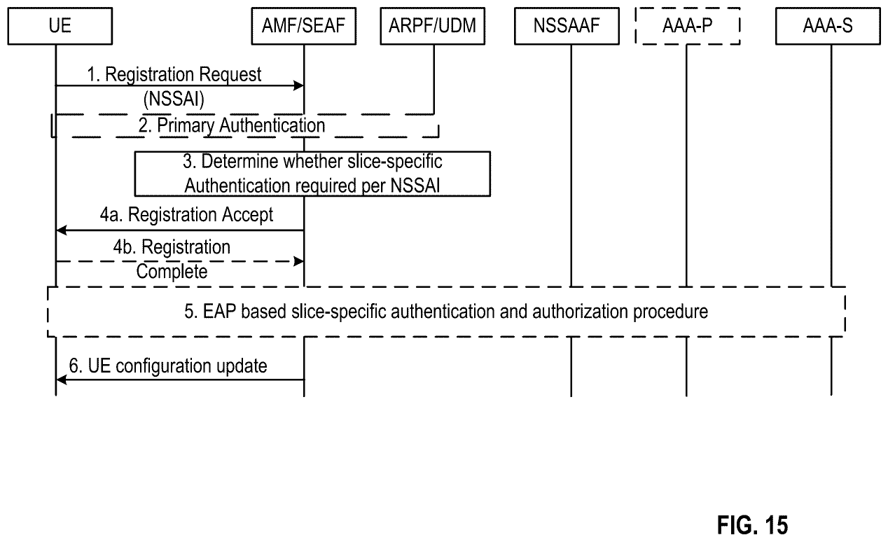

FIG. 15 illustrates examples of how a user equipment (UE) may fulfill prerequisites in order to gain access to a slice within a 3GPP system that requires network slice specific authentication and authorization (NSSAA).

In an example, the UE may send a registration request to an access and mobility management function (AMF). For example, the registration request may include a list of single network slice selection assistance information (S-NSSAI). For example, each S-NSSAI may refer to a slice the UE wants to gain access to.

In an example, the AMF may determine to perform primary authentication. For example, if the AMF hold no a valid security context for the UE, the AMF may trigger a primary authentication run. For example, if the AMF already holds the valid security context for the UE, the primary authentication may be skipped.

In an example, the primary authentication may be based on 5G-authentication and key agreement (5G-AKA) or Extensible Authentication Protocol-Authentication and Key Agreement' (EAP-AKA'), for a 5G network and for standalone non-public networks (SNPNs) the primary authentication may additionally be based on key generating extensible authentication protocol (EAP) methods. For example, a key generating EAP method may be extensible authentication protocol-transport layer security (EAP-TLS). The primary authentication takes place before NSSAA and is an independent procedure.

In an example, the AMF may determine whether NSSAA is required for each S-NSSAI based on locally stored information or retrieve information from a unified data management (UDM). The AMF may omit NSSAA for an S-NSSAI in the following cases: subscription information indicates that NSSAA is not required; the UE has previously completed NSSAA successfully, regardless of access type, and the result is still valid or NSSAA for the UE is currently ongoing. For example, access type may refer to 3GPP access, non-3GPP access and/or the like.

In an example, the AMF may send a registration accept message to the UE after determining the appropriate S-NSSAIs. For example, determining the appropriate S-NSSAIs may refer to determining allowed, rejected, pending and/or the like. The registration accept message may indicate the allowed S-NSSAIs, rejected S-NSSAIs and pending S-NSSAIs for the UE. Optionally, the UE may send a Registration Complete message to the AMF to confirm the registration process.

For example, allowed S-NSSAIs may refer to slices the UE is allowed to use. For example, rejected S-NSSAIs may refer to slices the UE is not allowed to use. For example, pending S-NSSAIs may refer to slices that its currently unclear if the UE may use. For example, the pending S-NSSAIs may require NSSAA before determining if allowed or rejected.

In an example, the AMF may perform NSSAA for the slices that require authentication. For example, NSSAA (slice specific authentication and authorization procedure) may be based on EAP.

In an example, the AMF may send a UE Configuration Update message to the UE after completing the NSSAA procedure for each required S-NSSAI. The UE configuration update message may indicate the status of the requested S-NSSAIs based on the results of the NSSAA. For example, the result may be either successful or unsuccessful. Depending on the result, the UE may place S-NSSAIs in allowed NSSAI for successful NSSAA or rejected NSSAI for unsuccessful NSSAA.

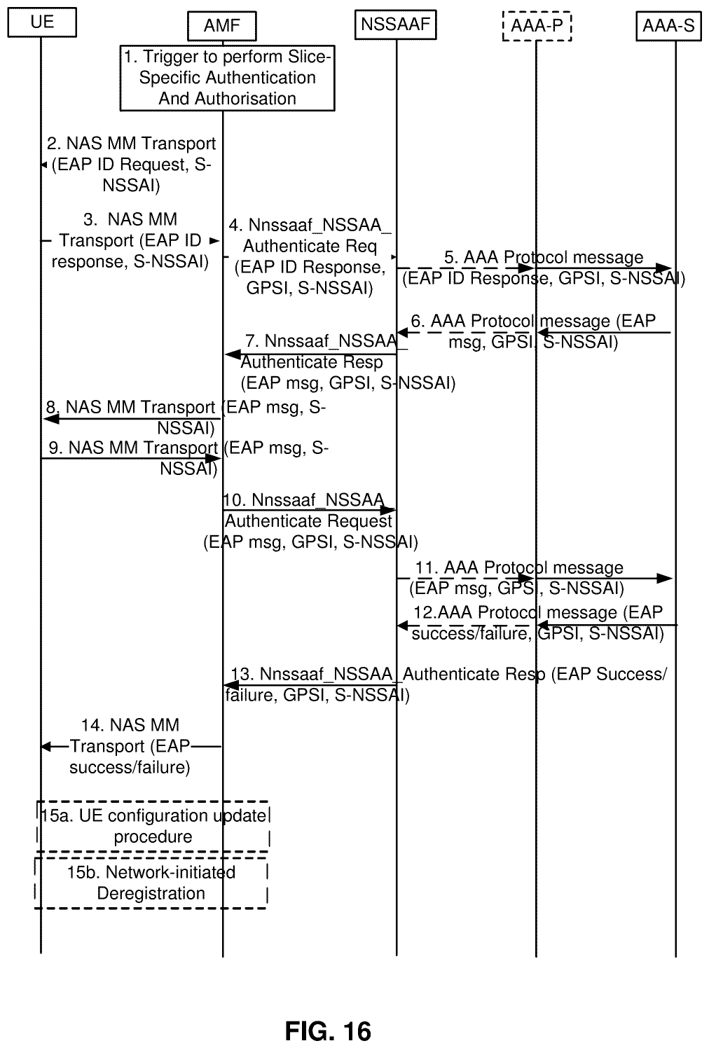

FIG. 16 illustrates examples of how a user equipment (UE) may perform NSSAA, to gain access to a slice within a 5G system (5GS) that requires NSSAA.

In an example, the authentication takes place between a UE and an authentication, authorization and accounting server (AAA-S). The AAA-S may be part of a 5G system (5GS), or external to the 5GS and may be owned by a different entity than the 5GS. The NSSAA relies on different credentials than the ones used for primary authentication towards a public land mobile network (PLMN). NSSAA relies on the extensible authentication protocol (EAP) framework where an AMF may take the role of an EAP authenticator and communicates with the AAA-S via a network slice-specific and standalone non-public network, SNPN, authentication and authorization function (NSSAAF). In an example, the NSSAAF may contact the AAA-S via a proxy in case the AAA-S is external to the 5GS.

In an example, a S-NSSAI may require NSSAA due to a change in subscription information or due to a trigger by the AAA-S, the AMF may initiate the NSSAA procedure in response to the change in subscription information or the trigger by the AAA-S. If the NSSAA is triggered during a registration procedure, the AMF may determine from the UE Context that the UE has already been authenticated for some or all S-NSSAI(s) during registration over a first access. For example, the UE may have registered over 3GPP access first and then attempts to register over a second access e.g., non-3GPP access. Depending on the previous NSSAA results and network policies, the AMF may choose to skip NSSAA for those S-NSSAIs during the second access registration.

For example, if the AMF holds a slice authentication result indicating successful NSSAA for a slice, the AMF may determine to skip NSSAA over the other access type for the same slice. If the NSSAA procedure is triggered by a re-authentication and re-authorization process initiated by the AAA server or by operator policy or subscription change, and if S-NSSAIs requiring NSSAA are part of an allowed NSSAI for each access type, the AMF may select an access type based on network policies to perform the NSSAA procedure.

In an example, the AMF may request an EAP Identity (ID) for EAP authentication for the S-NSSAI to be authenticated with NSSAA. This request for EAP ID may be made by the AMF through a NAS MM Transport message that includes the corresponding S-NSSAI. The UE can respond to this request by providing the EAP ID (EAP ID response) for the specified S-NSSAI, along with the S-NSSAI, in an NAS MM Transport message directed towards the AMF.

In an example, the AMF may send a Nossaaf_NSSAA_Authenticate Request to the NSSAAF, which acts as an interface with the AAA-S. The Nnssaaf_NSSAA_Authenticate Request may comprise the EAP ID, a global public subscriber identity (GPSI) and the S-NSSAI.

In an example, if an authentication, authorization and accounting proxy (AAA-P) is present, the NSSAAF may send the Nnssaaf_NSSAA_Authenticate Request to the AAA-P. However, if no AAA-P is present, the NSSAAF may directly forward the Nnssaaf_NSSAA_Authenticate Request to the AAA-S. The NSSAAF may determine the routing based on the S-NSSAI. For example, routing may refer to determining the AAA-S to which the Nnssaaf_NSSAA_Authenticate Request is sent.

In an example, the AAA-S may receive a AAA protocol message comprising the EAP ID, the GPSI and the S-NSSAI. For example, the AAA-S may store the GPSI to establish an association with the EAP ID. This allows the AAA-S to later revoke authorization or trigger reauthentication. Using the EAP-ID and S-NSSAI, the AAA-S can identify the UE and the slice for which authorization is being requested. If the AAA-S belongs to a third party, the NSSAAF may optionally map the S-NSSAI to external network slice information (ENSI). The NSSAAF may then forward the Nnssaaf_NSSAA_Authenticate Request to the AAA-S, comprising the ENSI, the GPSI and the EAP ID. In an example, the AAA-S may use the EAP-ID and ENSI to identify the UE for which slice authorization is requested.

In an example, during NSSAA, a one or several EAP-messages are exchanged between the UE and the AAA-S. Once the EAP authentication (NSSAA) is complete, the AAA-S may hold an EAP-Success/Failure indication.

In an example, the AAA-S may send the EAP-success/failure indication in a second AAA protocol message to the NSSAAF/AAA-P. For example, the second AAA protocol message may include the GPSI and the S-NSSAI/ENSI.

In an example, the NSSAAF may send to the AMF a Nossaaf_NSSAA_Authenticate Response comprising EAP-success/Failure, S-NSSAI and GPSI. For example, the AMF may transfer the result to the UE. The results of the NSSAA (EAP-Success/Failure) may require the AMF to update the UE's allowed and rejects S-NSSAIs. For example, the AMF may put the S-NSSAI in an allowed in an allowed NSSAI if the AMF received EAP-Success. For example, the AMF may put the S-NSSAI in a rejected NSSAI if the AMF received EAP-failure.

In an example, the AMF may perform a UE configuration update procedure with the UE. For example, the UE configuration update procedure may be used to update the UE's allowed NSSAI and/or rejected NSSAI.

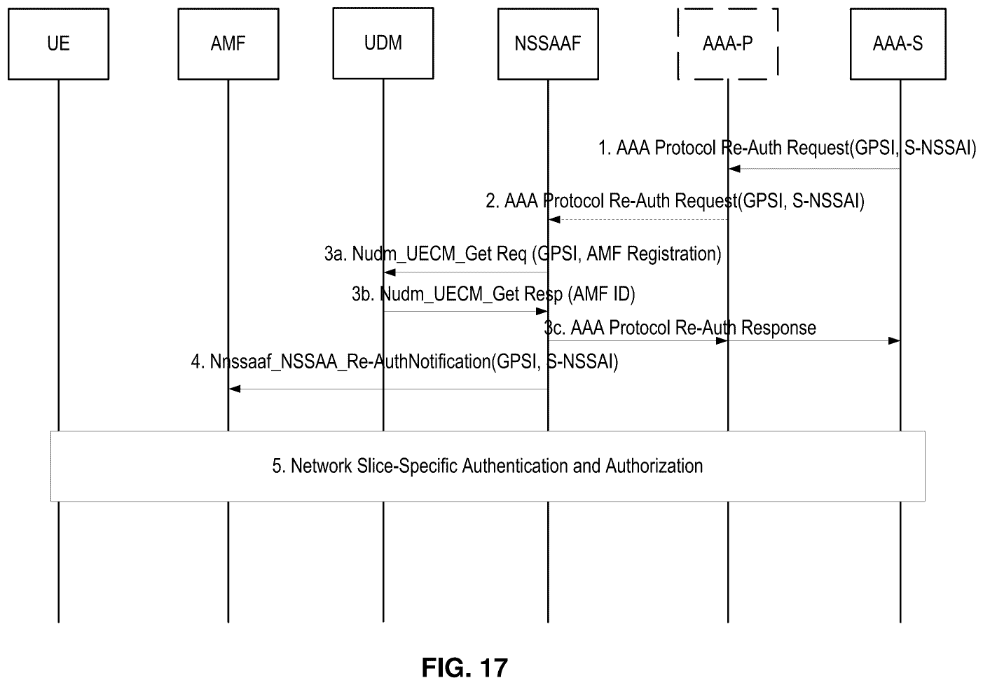

FIG. 17 illustrates an example of how an AAA-S may perform re-authentication and re-authorization by triggering NSSAA for a UE.

In an example, the AAA-S may request re-authentication and re-authorization for a network slice identified by a S-NSSAI. For example, the AAA-S may send a request using an AAA protocol Re-Auth Request message. The AAA protocol Re-Auth Request message may comprise a GPSI and the S-NSSAI. If an AAA-P is being used (for example, if the AAA-S belongs to a third party), the Re-Auth Request message may be sent to the AAA-P and then relayed to the NSSAAF. Otherwise, the message may be sent directly to the NSSAAF.

In an example, to determine a serving AMF to use for the re-authentication and re-authorization procedure, the NSSAAF may obtain an AMF ID of the serving AMF from a UDM.

In an example, the AMF sends a Nudm_UECM_Get request to the UDM, comprising the GPSI included in the AAA message received from the AAA-S. For example, the UDM may based on the GPSI determine the serving AMF for the UE associated with the GPSI.

In an example, the NSSAAF may receive conflicting information about the AMF address from the UDM (for example, if two different addresses are returned), it may either send a Nossaaf_NSSAA_ReAuthNotification to both AMFs or decide to notify the AMF first. If the first notification fails, the NSSAAF may then send the Nnssaaf_NSSAA_ReAuthNotification to a second AMF. For example, the Nnssaaf_NSSAA_ReAuthNotification may comprise the GPSI and the S-NSSAI.

In an example, the NSSAAF may send an acknowledgement to the AAA-S in a AAA protocol Re-Auth Response message. If the AMF is not registered in the UDM, the procedure may stop at this point.

In an example, the AMF has been determined and confirmed to be registered in the UDM, the NSSAAF may notify the AMF to initiate the re-authentication and re-authorization procedure for the specified S-NSSAI and UE using the Nnssaaf_NSSAA_Re-AuthNotification message. This message may include the GPSI and the S-NSSAI. A callback universal resource information (URI) for the notification to the AMF may be derived using a network repository function (NRF).

In an example, in response to receiving the Nnssaaf_NSSAA_Re-AuthNotification from the NSSAAF, the AMF checks if the UE is registered with the S-NSSAI in a mapping of allowed NSSAI. If the UE is registered to the S-NSSAI, the AMF triggers the NSSAA procedure for the S-NSSAI. The AMF selects an access type to perform NSSAA based on network policies if the S-NSSAI is included in an allowed NSSAI for 3GPP access and non-3GPP access. If the S-NSSAI is only included in the Allowed NSSAI of non-3GPP access and the UE is in CM-IDLE state in non-3GPP access, the AMF marks the S-NSSAI as pending. In this case, when the UE becomes CM-CONNECTED in non-3GPP access, the AMF initiates NSSAA if required. If the UE is registered but the S-NSSAI is not in the mapping of allowed network slice selection assistance information (NSSAI) the AMF removes any status of the corresponding S-NSSAI subject to NSSAA in a UE context associated with the UE. For example, a new NSSAA may be executed next time the UE requests to register with the S-NSSAI.

In an example, the procedure described is used for reauthentication and reauthorization, in a similar way, the AAA-S may trigger slice specific authorization revocation. For example, the AMF may receive a revocation notification and may update the allowed and rejected NSSAI(s) for the targeted UE based on the revocation notification.

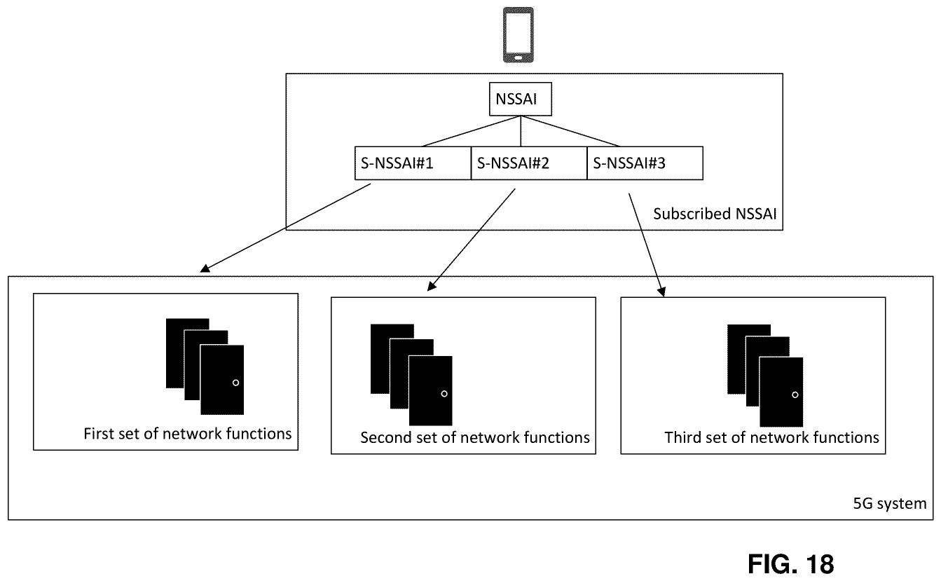

FIG. 18 illustrates an example of network slices.

In an example a UE may have a subscribed NSSAI. For example, the subscribed NSSAI may refer to a list of a one or several network slices the UE may use.

In an example, the UE may have a first slice (S-NSSAI #1), a second slice (S-NSSAI #2) and a third slice (S-NSSAI #3) in the subscribed NSSAI.

In an example, the first slice may be associated with a first set of network functions, the second slice associated with a second set of network functions and the third slice associated with a third set of network functions.

In an example, the first set of network functions, the second set of network functions and the third set of network functions may belong to a 5G system.

In an example, the first set of network functions associated with the first slice may require the UE successfully perform NSSAA before being granted access. For example, granted access may refer to the UE being allowed to use resources associated with the first set of network functions. For example, the first set of network functions may comprise one or several instances of a network function type. For example, the network function type may be a UPF, SMF, NSSAAF and/or the like.

In an example, the first slice, the second slice and the third slice may be of the same and/or different characteristics. For example, characteristics may refer to a slice being adjusted for vehicle to x (V2X), communication, enhanced mobile broadband (eMBB) communication and/or the like.

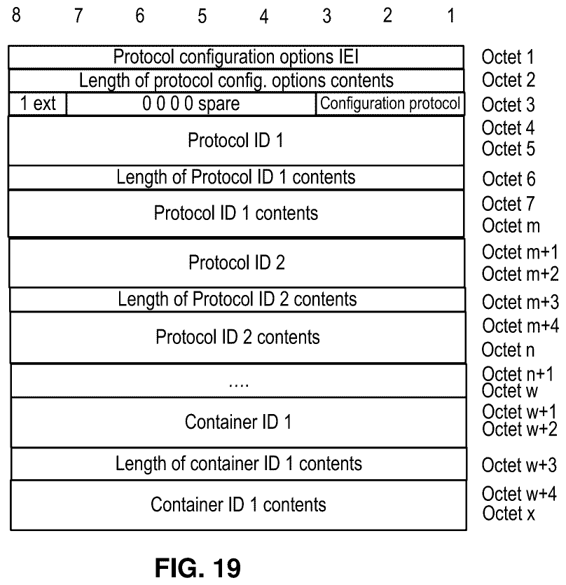

FIG. 19 illustrates an example of a protocol configuration options (PCO) information element (IE).

In an example, the PCO IE may comprise a first octet indicating an IE is the PCO IE. For example, the PCO IE may be carried as a part of a NAS message. For example, an octet may refer to eight bits.

In an example, a second octet of the PCO IE may define the length of the PCO IE.

In an example, a third octet of the PCO IE may comprise a configuration protocol field comprising three bits. For example, the configuration protocol field may indicate point to point protocol (PPP), PPP for use with internet protocol (IP) packet data protocol (PDP) type or IP packet data network (PDN) type and/or the like. For example, the third octet may comprise spare bits.

In an example, the PCO IE may comprise a configuration protocol options list and an additional parameters list. For example, the configuration protocol options list may start at octet four and stop at octet w.

In an example, the configuration protocol options list may comprise a variable number of logical units. For example, the logical units may occur in an arbitrary order within the configuration protocol options list. For example, each logical unit may be of variable length and comprise a protocol identifier field (protocol ID 1), a length of a protocol identifier contents of the logical unit field and the protocol identifier contents field.

In an example, the additional parameters list may start at octet w+1 and stop at octet x. For example, the additional parameters list may be used when special parameters and/or requests need to be transferred between a UE and a network. For example, the network may be an EPS.

In an example, the additional parameters list may comprise a list of special parameters. For example, a special parameter may be encoded into a separate container. For example, a type of the special parameter may be identified with a specific container identifier.

In an example, a container identifier field (container ID1) may be encoded as the protocol identifier field. In an example, a length of container ID 1 contents may be encoded as the length of the protocol identifier contents. In an example, a container ID 1 contents field may be empty or contain data. For example, the container ID 1 contents field may be empty or contain data based on contents of the container identifier field.

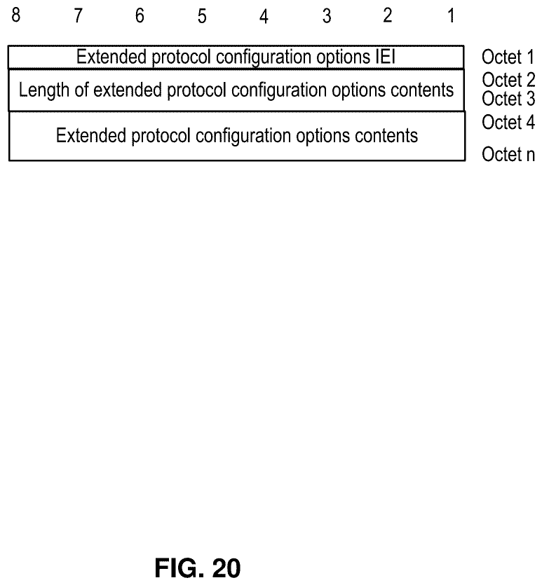

FIG. 20 illustrates an example of an extended protocol configuration options (PCO) information element (IE).

In an example the extended PCO IE may be encoded as described for a PCO IE in FIG. 19. Reverting back to FIG. 20, the extended PCO IE may comprise more data than the PCO IE.

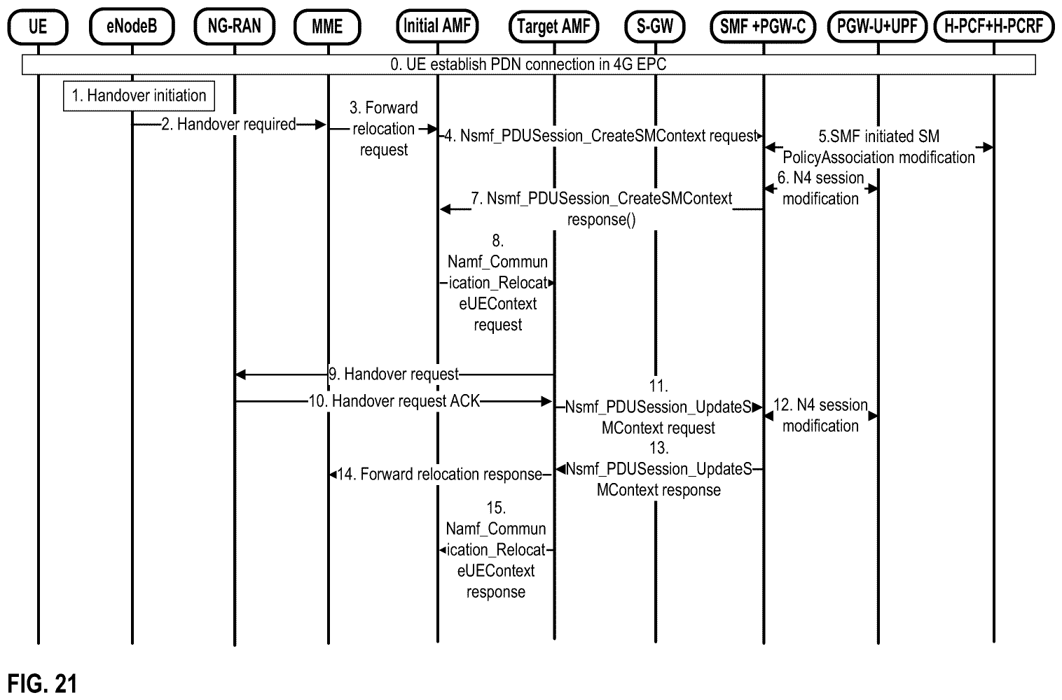

FIG. 21 illustrates an example of a handover from an EPS to a 5GS.

In an example, a UE may establish a packet data network (PDN) connection in an evolved packet core (EPC). For example, the EPC may be a 4G network. For example, the PDN connection may be used to send and receive data.

In an example, an evolved Node B (eNodeB) associated with the EPC, may initiate a handover to the 5GS for the UE. For example, the eNodeB may initiate the handover based on dynamic information learnt by the eNodeB, in response to an unsuccessful Xn handover and/or the like. For example, the handover may be S1 based.

In an example, the eNodeB may send a handover required message to a mobility management entity (MME).

For example, the handover required message may comprise information about a target gNb (NG-RAN). For example, the handover may refer to moving the UE from a first base station to a second base station.

In an example, the MME may send a forward relocation request message to an initial AMF. For example, the forward relocation request message may comprise an EPS mobility management (MM) context associated with the UE.

In an example, the initial AMF may convert the EPS mobility management context into a 5GS MM context. For example, converting may refer to converting an EPS security context into a mapped 5G security context and/or the like.

In an example, the forward relocation request message may comprise an EPS bearer context(s). For example, the EPS bearer context may comprise for a PDN connection, an internet protocol address, a fully qualified domain name (FQDN) for a S5/S8 interface of an SMF+packet gateway-control plane (PGW-C), an access point name (APN) and/or the like.

In an example, the EPS bearer context(s) may comprise for an EPS bearer of the PDN connection, an IP address and core network tunnel info at a UPF+packet gateway-user plane (PGW-U).

In an example, the initial AMF sends (invokes) a Nsmf_PDUSession_CreateSMContext request to the SMF+PGW-C. For example, the Nsmf_PDUSession_CreateSMContext request may comprise a UE EPS connection, an initial AMF ID, a data forwarding information, a target ID and/or the like. For example, the initial AMF may send the Nsmf_PDUSession_CreateSMContext request to the SMF+PGW-C associated with the UE EPS connection.

In an example, the initial AMF may invoke the SMF+PGW-C for each PDN connection associated with the SMF+PGW-C. For example, some PDN connections may be associated with a different SMF+PGW-C. In an example, an SMF of the SMF+PGW-C may find corresponding a PDU session based on the EPS bearer context(s).

In an example, if dynamic policy and charging is deployed, the SMF+PGW-C may initiate SMF initiated SM Policy modification towards a policy control function (PCF).

In an example, the SMF+PGW-C may request the PGW-U+UPF to allocate the CN tunnel for the PDU Session at PGW-U+UPF.

In an example, the SMF+PGW-C may send a N4 session modification to the PGW-U+UPF to establish the CN tunnel for the PDU session at the PGW-U+UPF. For example, the PGW-U+UPF may be ready to receive uplink packets from the target gNb (NG-RAN).

In an example, the PGW-U+UPF may allocate a PGW-U CN Tunnel Info for the PDU Session and send it to the SMF+PGW-C.

In an example, the SMF+PGW-C may send a Nsmf_PDUSession_CreateSMContext response to the initial AMF. For example, the Nsmf_PDUSession_CreateSMContext response may comprise a PDU session ID, an S-NSSAI, an allocated EPS bearer identities, N2 signaling management information and/or the like.

In an example, the initial AMF may based on the S-NSSAI received from the SMF+PGW-C determine a target AMF. For example, the initial AMF may not be able to provide service for the S-NSSAI. For example, if the initial AMF determines the initial AMF cannot serve the S-NSSAI, the initial AMF may send a Namf_Communication_RelocateUE context request to the target AMF. For example, the Namf_Communication_RelocateUE context request may comprise a SUPI, an ID on the gNb, the PDU session ID, the S-NSSAI, the N2 signaling management information and/or the like.

In an example, the target AMF may send a handover request to the gNb. For example, the handover request may comprise an allowed NSSAI, the PDU session ID, the S-NSSAI received from the source AMF associated with the N2 signaling management information and/or the like.

In an example, the gNb may send a handover request acknowledge (handover request ACK) to the target AMF. For example, the handover request acknowledge may comprise a list of PDU sessions to handover with an N2 SM response. For example, the N2 SM response may comprise an access tunnel info, a data forwarding tunnel info, the PDU session ID and/or the like.

In an example, the target AMF may send an Namf_Communication_RelocateUE context request to the SMF part of the SMF+PGW-C. For example, the purpose of the Namf_Communication_RelocateUE context request may be to update N3 tunnel information.

In an example, the SMF+PGW-C may send a N4 session modification message to the UPF. For example, the N4 session modification message may be used to the N3 UP address and the tunnel ID of the gNb. For example, the purpose of sending the N4 session modification message may be to prepare for a N2 handover if N2 handover is accepted by the gNb.

In an example, the SMF+PGW-C may send a Nsmf_PDUSession: UpdateSMContext response to the target AMF comprising the PDU session ID, an EPS bearer setup list and/or the like.

In an example, the target AMF may send a forward relocation response to the MME. For example, the forward relocation response may comprise the EPS bearer setup list, a cause, a serving GW change indication, the target AMF's tunnel endpoint identifier for control plane and/or the like.

In an example, the target AMF may send a Namf_Communication_relocateU EContext response to the initial AMF. For example, the Namf_Communication_relocateUEContext response may comprise an indication of if the handover was successful. For example, successful may refer to moving the UE from EPS to 5GS.

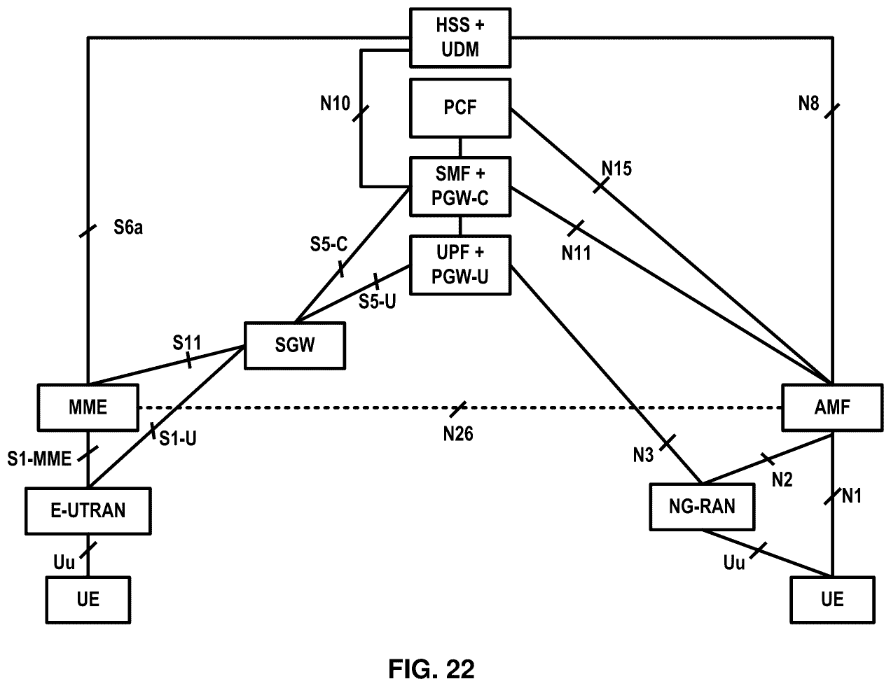

FIG. 22 may depict an example network architecture for inter-system interworking between a 4G system (e.g., 4G network) and a 5G system (e.g., 5G network) in accordance with embodiments of the present disclosure. Left side of the FIG. 22 may be the 4G system comprising an MME, a E-UTRAN and an SGW. The right side of the FIG. 22 may be the 5G system comprising an AMF, a NG-RAN. A UE (e.g., wireless device) may connect to the E-UTRAN or the NG-RAN via the Uu interface. The UE may be a wireless device. The Uu interface between the E-UTRAN and the wireless device may be an LTE Uu. The Uu interface between the NG-RAN and the wireless device may be a NR Uu. One or more nodes or network functions may be common network nodes or common network functions which are shared between the 4G system and the 5G system. The common network nodes may comprise a subscription information storage function (e.g., HSS+UDM), a policy function (PCRF+PCF), control plane gateway functions (SMF+PGW-C), user plane gateway functions (UPF+PGW-U) and/or the like. In an example, the common network nodes may comprise the 4G system function and the 5G system function to employ an interworking when the wireless device moves between a E-UTRAN coverage area and a NG-RAN coverage area.

In FIG. 22, there is a N26 interface between the MME and the AMF. The N26 interface may be an inter-core network interface between the MME of 4G system and the AMF of the 5G system. The N26 may enable interworking between the 4G system and the 5G system. Networks that support interworking between the 4G system and the 5G system, may support interworking procedures that use the N26 interface or interworking procedures that do not use the N26 interface. A network node (e.g., MME, AMF) may indicate to the wireless device whether the network supports interworking procedure with N26 or without N26. The network node may indicate whether the network supports interworking procedure with N26 or without N26, by sending an interworking parameter to the wireless device. If the network supports N26 interface (e.g., interworking procedure with N26), the interworking parameter may be set as “interworking without N26 interface not supported”. If the network does not support N26 interface (e.g., interworking procedure without N26), the interworking parameter may be set as “interworking without N26 interface supported”.

In an example, the interworking procedures using the N26 interface, may enable an exchange of mobility management context and session managements states (e.g., contexts) of the wireless device between the 4G system and the 5G system. When the interworking procedures with N26 is used, the wireless device may operate in a single-registration mode. For the single-registration mode, the wireless device may keep one valid registration (e.g., attach) association either with the 4G system in the MME or with the 5G system in the AMF. When interworking procedures without N26 is used, the wireless device may operate in a dual-registration mode. In dual-registration mode, the wireless device may perform independent registration for the 4G system and the 5G system. In dual-registration mode, the wireless device may be allowed to register with the 5G system and to attach (e.g., register) with the 4G system simultaneously.

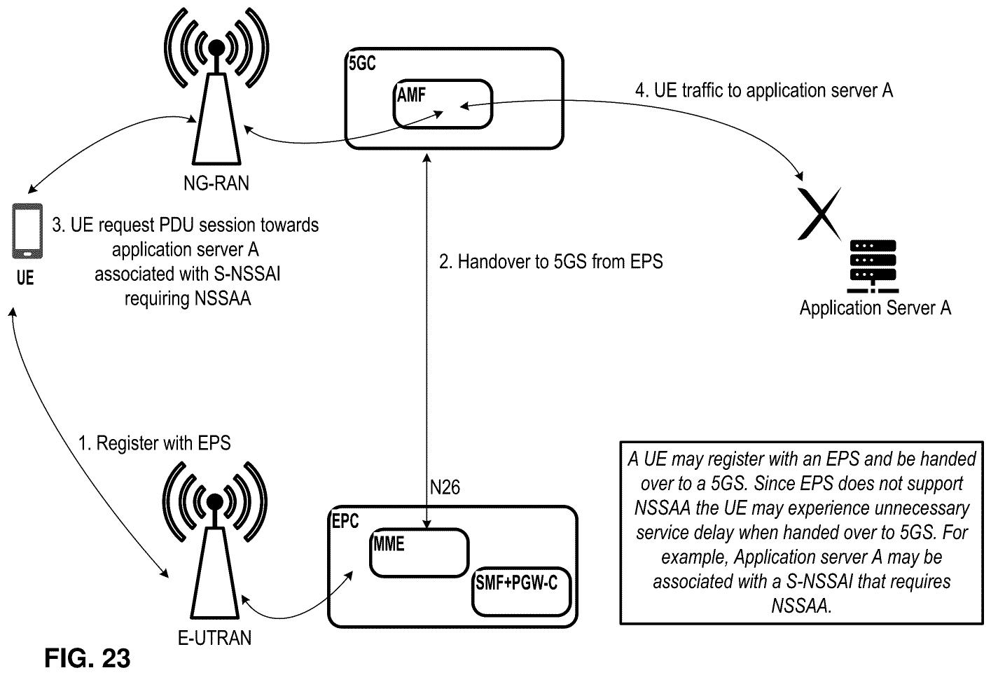

FIG. 23 may illustrate an example of how interworking may work when NSSAA is configured.

In an example, a wireless device (UE) may send a registration request to an EPC via a base station associated with the EPC. For example, the registration request may be an initial attach request message, PDN connectivity request message and/or the like.

In an example, the wireless device may receive an attach accept message. For example, the accept message may be part of an S1-AP downlink NAS transport message. The attach accept message may be sent to the wireless device by the base station (E-UTRAN) associated with the EPC in an RRC direct transfer message. For example, the wireless device may receive the attach accept message in response to sending the registration request to the EPC.

In an example, the base station associated with the EPC may determine to handover the wireless device to a base station associated with a 5G core (5GC).

For example, the base station associated with the EPC may determine to handover the wireless device based on coverage conditions, load conditions of the base station associated with the EPC and/or the like.

In an example, an MME of the EPC may receive a handover required message from the base station associated with EPC. For example, the handover required message may comprise an identity of the base station associated with the 5GC.

In an example, the MME may send a forward relocation request message to an AMF of the 5GC. For example, the forward relocation request message may comprise a context associated with the wireless device, PDN connections to transfer and/or the like.

In an example, the wireless device may send a PDU session request towards an application server A. For example, the wireless device may send the PDU session request to the 5GC via the base station associated with the 5GC. For example, the wireless device may send the PDU session request after being handed over from the EPC to the 5GC.

In an example, the PDU session may request a connection towards the application server A. For example, the application server A may be associated with an S-NSSAI. For example, the S-NSSAI may require the wireless device to perform NSSAA before accessing any services (the application server A) associated with the S-NSSAI.

In an example, the wireless device may be unable to request the PDU session directly after being handed over to the 5GC. For example, the wireless device may not have the S-NSSAI in an allowed NSSAI. For example, not having the S-NSSAI in the allowed NSSAI may prevent the wireless device from requesting the PDU session associated with the S-NSSAI.

In an example, the wireless device may have to perform additional signaling after being handed over to the 5GC before being able to access the application server A. For example, the wireless device may have to send a registration request to the 5GC. For example, the wireless device may have to send the registration request to the 5GC to trigger NSSAA for the S-NSSAI.

In an example, the wireless device may have to perform registration, including NSSAA, with the 5GC. For example, after registration and NSSAA the wireless device may get the S-NSSAI in the allowed NSSAI.

For example, the need for additional signaling after handover to the 5GC from the EPC may cause unnecessary delay before the wireless device can access the application server A leading to service degradation in scenarios with interworking.

In existing technologies, as shown in FIG. 23 a wireless device may have an access path of 3GPP access via an E-UTRAN with an evolved packet core (EPC) core (e.g., corresponding to a 4G system). Whilst serving the wireless device, the E-UTRAN may determine to handover the wireless device to an NG-RAN (e.g., corresponding to a 5G system). As a result, the wireless device (and/or a context of the wireless device) may be moved from the EPC to a 5G core (5GC).

In a 5G system (5GS), network slicing provides dedicated resources and/or services in the form of a slice to a group of wireless devices. In order to gain access to the slice, the wireless device may be required to perform slice authentication (NSSAA). The requirement of NSSAA may add an additional layer of security by giving access to the slice to the wireless device that successfully passes slice authentication (NSSAA).

As EPC and 5GS evolve and coexist, the EPC and 5GS may interwork with each other more closely. Since the EPC may be unable to perform NSSAA, a wireless device handed over from 5GC to EPC may be unable to access services (e.g., network slicing). Moreover, a wireless device handed over from EPC to 5GC may experience delay while NSSAA is performed. Handover between the 5GS and the EPC may cause inconsistency in the security level provided.

In examples of this disclosure, the handling of slice authentication may be enhanced to support slice authentication for a wireless device being handed over between EPC and 5GC. For example, an indication of support for NSSAA in EPC is introduced. The indication for support of NSSAA in EPC may be used by the EPC to determine the wireless device can perform NSSAA in EPC and therefore trigger NSSAA. For example, a wireless device may send, to a base station associated with an evolved packet system (EPS), a request message requesting a packet data network (PDN) connectivity. The request message may comprise the indication of support for NSSAA in EPC. The PDN connectivity may be associated with a network slice of a 5G system (5GS).

By implementing the aforementioned solution, the solution may aid in alleviating security complications introduced by supporting NSSAA in EPC, may help to keep good security hygiene, reduce potential disruption, and may improve user experience.

In this specification, support for network slice specific authentication and authorization (NSSAA) over EPC may refer to a capability of a wireless device (user equipment) or a network. For example, the wireless device may send the indication of support for NSSAA over EPC during registration, with a PDN connectivity request, with a PDU session establishment request and/or the like. For example, the wireless device may include the indication of support for NSSAA over EPC in a NAS message. For example, the UE may send the registration request to a 5GC or the EPC.

The indication of support for NSSAA over EPC may be encoded into a PCO information element identifier (IEI), an ePCO IEI, a 5G mobility management capability IEI, a 5G session management capability IEI, a UE context transferred between the EPC and the 5GC and/or the like.

For example, the indication of support for NSSAA over EPC may be encoded as a container identifier (ID) field of the PCO IEI, the ePCO IEI and/or the like. For example, a value may be encoded into the container identifier field. For example, the value may translate to indicating support for NSSAA over EPC.

The value may be a numerical value, a hexadecimal value, a string of characters, a binary value and/or the like. For example, encoding may refer to adding a value to the PCO IEI/ePCO IEI.

For example, a container ID contents field associated with the indication of support for NSSAA over EPC may be encoded as zero, comprise a generic public subscription identifier, be empty e.g., contain no data, comprise an S-NSSAI and/or the like. For example, inclusion of the GPSI in the PCO IEI, ePCO IEI may act as the indication of support for NSSAA over EPC.

The indication of support for NSSAA over EPC may be encoded as a dedicated information element within the 5GMM capability IEI and/or the like. In existing technologies, the 5GMM capability IE may indicate support for NSSAA.

In existing technologies, NSSAA is handled by the wireless device and an AMF of the 5GC at registration. In EPC, NSSAA may be handled by an SMF+PGW-C when the wireless device requests a PDN connectivity. For example, the SMF+PGW-C may need the indication of support for NSSAA over EPC to determine an action. For example, the SMF+PGW-C may receive a request message for the PDN connectivity. If the PDN connectivity is associated with a network slice requiring NSSAA the SMF+PGW-C may based on the indication of support for NSSAA over EPC determine to trigger NSSAA. Without the indication of support for NSSAA over EPS, PDN connections associated with the network slice requiring NSSAA may be rejected.

The indication of support for NSSAA over EPC may be used to determine if a PDU session of the wireless device associated with the network slice can be moved to the EPC. For example, the wireless device may have performed NSSAA with the AMF for the network slice based on the existing NSSAA support indication. The PDU session may be moved to the EPC if the wireless device supports NSSAA over EPC. The PDU session may not be moved to the EPC if the wireless device does not support NSSAA over EPC. For example, moving the PDU session associated with the network slice to the EPC without knowing if the wireless device can support NSSAA over EPC may lead to bypassing a layer of security provided by NSSAA.

The indication of support for NSSAA over EPC may be named indication of support for NSSAA in EPC, indication for support of NSSAA in EPS, indication of support for NSSAA during interworking with EPC, indication of support for NSSAA during interworking with EPS, indication of support during intersystem handover, indication of support for NSSAA via an EPS, indication of support for NSSAA via the EPS, indication of support for NSSAA via the EPC, indication of support for NSSAA via an EPC, indication of NSSAA support during intersystem handover and/or the like. For example, the indication of support for NSSAA over EPC may have the purpose to inform the EPS/EPC that the wireless device can handle messages associated with NSSAA in the EPS/EPC. For example, the message associated with NSSAA may be EAP-ID request/response, EAP messages related to NSSAA, receiving an EAP-Success and/or EAP-Failure and/or the like.

The indication of support for NSSAA over EPC may refer to the wireless device being able to perform NSSAA in response to requesting an APN associated with an S-NSSAI requiring NSSAA and/or the like.

The indication of support for NSSAA over EPC may imply a result of the NSSAA can be transferred from the EPS/EPC to a 5GS/5GC and/or the like. For example, the EPS may provide the result of the NSSAA over a N26 interface. For example, the result of the NSSAA may be an EAP-success, an EAP-Failure and the S-NSSAI and/or the like.

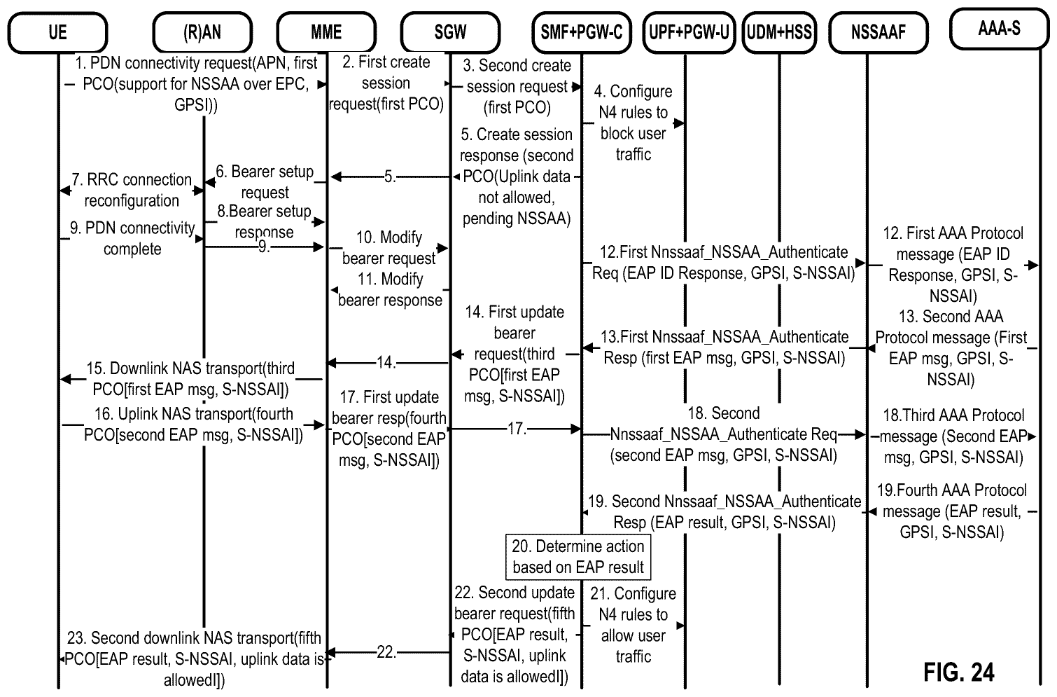

FIG. 24 may depict one example embodiment of the present disclosure. In an example, a wireless device (UE) may request a PDN connectivity for an APN associated with an S-NSSAI requiring NSSAA.

In an example, the wireless device may send a PDN connectivity request to an MME. For example, the PDN connectivity request may be sent via a base station ((R)AN). For example, the MME may be associated with an EPC. For example, the base station may be connected to the EPC. For example, the base station may be an eNodeB and/or the like.

In an example, the PDN connectivity request may indicate a support for NSSAA in EPC. For example, the support for NSSAA in EPC may be based on a dedicated information element in the PDN connectivity request. For example, indicating the support for NSSAA in EPC may be based on inclusion of a first PCO information element in the PDN connectivity request. For example, the first PCO information element, may comprise a first container ID for indicating the support for NSSAA in EPC and/or the like. For example, the first PCO information element may be an extended PCO information element and/or the like.

In an example, the support for NSSAA in EPC may be encoded as a first string in the first container ID and/or the like.

In an example, the wireless device may operate in S1 mode. For example, the wireless device may operate in S1 mode based on being redirected to the EPC from a 5GC. For example, S1 mode may imply the wireless device uses a first NAS protocol compatible with the EPC. For example, the wireless device may in N1 mode use a second NAS protocol compatible with the 5GC. For example, during interworking, the wireless device may change from the first NAS protocol to the second NAS protocol and/or the like.

In an example, the indication of support for NSSAA in EPC may be based on including a GPSI in the first PCO information element. For example, the GPSI may be encoded into a first container ID contents field of the first PCO information element. For example, the first container ID may comprise the first string encoded as a string and the first container ID contents field may comprise the GPSI. For example, the first container ID contents field may comprise a raw data representing the GPSI. For example, raw data may be a binary representation of the GPSI. For example, binary data may be represented by 1s an 0s.

In an example, the wireless device may be preconfigured with conditions to include the GPSI. For example, the wireless device may include the GPSI in the PDN connectivity request based on knowledge of an APN being associated with a slice that requires NSSAA (local configuration), configured to include the GPSI when sending the PDN connectivity request comprising an S-NSSAI, the PDN connectivity request comprising a PDU session ID and/or the like.

In an example, the wireless device may be preconfigured with conditions to include an EAP ID (EAP ID response). For example, the wireless device may include the EAP ID in the PDN connectivity request based on knowledge of an APN being associated with a slice that requires NSSAA (local configuration), configured to include the GPSI when sending the PDN connectivity request comprising an S-NSSAI, the PDN connectivity request comprising a PDU session ID, after handover from the 5GC to the EPC and/or the like. For example, the wireless device may determine the EAP ID based on the slice.

In an example, the MME may receive the PDN connectivity request.

In an example, the MME may send a first create session request to an SGW. For example, the first create session request may comprise the APN, the first PCO information element, an international mobile subscriber identity (IMSI) of the wireless device, an EPS bearer ID, a SMF+PGW-C address and/or the like. In an example, the MME may select the SMF+PGW-C address based on the APN. For example, the MME may be aware the APN is associated with the slice requiring NSSAA and selects the SMF+PGW-C address pointing to a SMF+PGW-C supporting NSSAA. In an example, the SGW may receive the first create session request from the MME.

In an example, the SGW may send a second create session request to the SMF+PGW-C. For example, the second create session request may comprise the first PCO information element, the IMSI, the APN and/or the like.

In an example, the SMF+PGW-C may receive the second create session request.

In an example, the SMF+PGW-C may select a UPF+PGW-U.

In an example, the SMF+PGW-C may send a N4 session establishment request message to the UPF+PGW-U. For example, the purpose of the N4 session establishment request message may be to setup an N4 rules to block user traffic for the requested PDN connection. For example, the N4 rules to block user traffic may be active until the wireless device has successfully performed NSSAA and/or the like.

In an example, the SMF+PGW-C may receive a N4 session establishment response message from the UPF+PGW-U.

In an example, the SMF+PGW-C may send a first create session response to the SGW. For example, the create session response message may comprise an indication of uplink data not allowed. For example, the indication of uplink data not allowed may be carried in a second PCO information element. For example, the indication of uplink data not allowed may be encoded as a second container ID. For example, the second container ID may be part of the second PCO information element. For example, encoded may refer to the second container ID being encoded as a second string. For example, the second string may comprise uplink data not allowed.

In an example, the indication of uplink data not allowed may be expanded to further indicate pending NSSAA. For example, pending NSSAA may imply the wireless may have to perform NSSAA before being allowed to send uplink data for the PDN connection.

In an example, a second container ID may be encoded as a third string indicating NSSAA pending. In an example, the second container ID may indicate uplink data not allowed and a second container ID contents field may comprise the third string.

In an example, the second PCO information element may further comprise the S-NSSAI that requires NSSAA.

In an example, the SGW may receive the first create session response.

In an example, the SGW may send a second create session response to the MME. For example, the second create session response may comprise the second PCO information element and/or the like.

In an example, the MME may receive the second create session response.

In an example, the MME may send a bearer setup request to the base station. For example, the bearer setup request message may comprise the second PCO information element from the second create session response. For example, the bearer setup request message may be a S1_MME control message. For example, the second PCO information element from the second create session response may be carried in a PDN connectivity accept message. For example, the PDN connectivity accept message may be carried within the bearer setup request message.

In an example, the base station may send the PDN connectivity accept message to the wireless device in an RRC connection reconfiguration message.

In an example, the wireless device may receive the PDN connectivity accept message. For example, the PDN connectivity accept message may comprise the second PCO information element.

In an example, the wireless device may based on receiving the indication for pending NSSAA and the S-NSSAI requiring NSSAA in the PDN connectivity accept message determine an EAP ID (EAP ID Response) for the S-NSSAI.

In an example, the base station may send a bearer setup response to the MME.

In an example, the wireless device may send a PDN connectivity complete message to the base station. In an example, the base station may send the PDN connectivity complete message to the MME.

In an example, the MME may send a modify bearer request to the SGW. For example, the MME may receive a modify bearer response from the SGW.

In an example, the SMF+PGW-C may determine the APN is associated with the slice that requires NSSAA based on local configuration or by interacting with a UDM+HSS. For example, interacting with the UDM may refer to sending a first Nudm_Get request to the UDM+HSS requesting NSSAA information for the APN. For example, the first Nudm_Get request may comprise the IMSI, the APN, the S-NSSAI associated with the APN, an identity of the SMF+PGW-C, the PDU session ID and/or the like.

In an example, the UDM+HSS may respond to the first Nudm_Get request with a first Nudm_get response. For example, the first Nudm_get_response may comprise an indication of NSSAA requirement for the S-NSSAI, the GPSI and/or the like. For example, the indication of NSSAA requirement may imply NSSAA is required or not needed. For example, if the SMF+PGW-C did not receive the GPSI in the create session request, the GPSI may be provided by the UDM+HSS. For example, the SMF+PGW-C may receive a GPSI different from the GPSI from the UDM+HSS. If the SMF+PGW-C receives the GPSI different from the GPSI from the UDM+HSS, the GPSI different from the GSPI may take precedence over the GPSI received from the wireless device in the PDN connectivity request.

In an example, the GPSI used for NSSAA in EPC may be different from a second GPSI used in a 5GS for NSSAA. For example, using a different GPSI per system e.g. EPS/EPC and 5GS/5GC can allow a system interworking between EPS and 5GS to keep track of in which system NSSAA was performed. For example, the system interworking can be configured to allow transfer of NSSAA results from EPS to 5GS, from 5GS to EPS, in one direction, in both directions, determine a shorter validity of NSSAA results from EPS being transferred to 5GS, requiring to trigger NSSAA at handover if the NSSAA result origins from a different system (moving to 5GS and NSSAA result is from EPS or vice versa), requiring to trigger NSSAA at handover if the NSSAA result originates from the system the wireless device is being handed over to (back to 5GS from EPS or vice versa) and/or the like.

In an example, the SMF+PGW-C may trigger NSSAA. For example, the SMF+PGW-C may trigger NSSAA based on local configuration, information received from the UDM+HSS, an earlier NSSAA result may have expired and/or the like. For example, the SMF+PGW-C may check internally if the SMF+PGW-C has the stored NSSAA result for the S-NSSAI for the wireless device associated with the APN in the PDN connectivity request.

In an example, the SMF-PGW-C may trigger NSSAA by sending a first Nnssaaf_NSSAA_authenticate request message to a NSSAAF. For example, the first Nnssaaf_NSSAA_authenticate request message may comprise the S-NSSAI associated with the APN, the EAP ID, the GPSI and/or the like. For example, the EAP ID may be available locally in the SMF+PGW-C or requested by the SMF+PGW-C.

For example, requested by the SMF+PGW-C may imply sending, not depicted, by the SMF+PGW-C a third update bearer request message to the wireless device. For example, the third update bearer request message may comprise a sixth PCO information element comprising an EAP identity request, the S-NSSAI and/or the like.

In an example, the wireless device may respond with a third update bearer response comprising in a seventh PCO information element, the EAP ID and the S-NSSAI.

In an example, the NSSAAF may receive the first Nnssaaf_NSSAA_authenticate request from the SMF+PGW-C. For example, the NSSAAF may receive the first Nnssaaf_NSSAA_authenticate request via an interface between the NSSAAF and the SMF+PGW-C. For example, the interface may be service based, the interface may be used in a service based architecture (SBA), the interface may rely on a diameter protocol, the interface may rely on a remote authentication dial-in user service (RADIUS) protocol and/or the like.

In an example, the NSSAAF may convert the first Nnssaaf_NSSAA_authenticate request from being a service based message to a message of an authentication authorization and accounting (AAA) protocol. For example, the first Nnssaaf_NSSAA_authenticate request may be converted into a first AAA protocol message. For example, the first AAA protocol message may comprise the EAP ID, the GPSI, the GPSI different from the GPSI, the S-NSSAI and/or the like.

In an example, the NSSAAF may send the first AAA protocol message to an AAA-S.

In an example, the AAA-S may receive the first AAA protocol message. For example, the AAA-S may initiate NSSAA for the wireless device. For example, the AAA-S may determine to initiate NSSAA based on the EAP ID and the S-NSSAI. For example, the AAA-S may make an association between the GPSI and the EAP ID. For example, the AAA-S may by knowing the association between the GPSI and the EAP ID trigger reauthentication for the wireless device.

In an example, the EPS may carry several EAP messages between the AAA-S and the wireless device. For example, the number of EAP messages exchanged between the AAA-S and the wireless device may depend on an authentication method. For example, a first authentication method may require one round trip of EAP messages, a second authentication method may require more than one round trip of EAP messages and/or the like. For example, the AAA-S may select the authentication method based on a credential associated with the EAP ID.

In an example, the AAA-S may send a second AAA protocol message to the NSSAAF. For example, the second AAA protocol message may comprise a first EAP message (first EAP msg), the GPSI, the S-NSSAI and/or the like.

In an example, the NSSAAF may receive the second AAA protocol message from the AAA-S. In an example, the NSSAAF may convert the second AAA protocol message to a first Nnssaaf_NSSAA_Authenticate response message (first Nnssaaf_NSSAA_Authenticate resp). For example, convert may refer to copying parameters from the second AAA protocol message to the first Nnssaaf_NSSAA_Authenticate response message. For example, the parameters may be the GPSI, the first EAP message, the S-NSSAI and/or the like.

In an example, the NSSAAF may send the first Nnssaaf_NSSAA_Authenticate response message to the SMF+PGW-C via the interface. For example, the NSSAAF may route the second AAA protocol message after converting it to the first Nnssaaf_NSSAA_Authenticate response message to the SMF+PGW-C.

In an example, the NSSAAF may based on an association between the GPSI and the S-NSSAI determine an address of the SMF+PGW-C.

In an example, the NSSAAF may have an established session with the SMF+PGW-C. For example, the established session may imply a logical connection between the SMF+PGW and the NSSAAF. For example, the NSSAAF may receive the first NNssaaf_NSSAA_Authenticate request message over the logical connection and send the first Nnssaaf_NSSAA_Authenticate response message over the logical connection. For example, the NSSAAF may send the first Nnssaaf_NSSAA_Authenticate response message over the same logical connection the SMF+PGW-C received the first NNssaaf_NSSAA_Authenticate request message.

In an example, the NSSAAF may send a Nudm_Get request to the UDM+HSS to determine the address of the SMF+PGW-C. For example, the Nudm_Get request may comprise the GPSI and the S-NSSAI and/or the like. For example, the UDM+HSS may respond with the address of the SMF+PGW-C in a Nudm_Get response message and/or the like.

In an example, the SMF +PGW-C may receive the first Nnssaaf_NSSAA_Authenticate response message.

In an example, the SMF+PGW-C may determine to send a first update bearer request to the wireless device. For example, the SMF+PGW-C may encode the first EAP message and the S-NSSAI into the first update bearer request. For example, the first EAP message and the S-NSSAI may be encoded as information elements of a third PCO information element. For example, the first EAP message may be encoded as a third container ID contents field, a third container ID and or the like. For example, the third container ID contents field may comprise the first EAP message. For example, the S-NSSAI may be encoded into a fourth container ID contents field or combined with the first EAP message. For example, the third container ID may comprise the S-NSSAI and the third container ID contents field may comprise the first EAP message and/or the like. For example, the third PCO information element may comprise the third container ID contents field, the third container ID, the fourth container ID and/or the like.

In an example, the SMF+PGW-C may in response to sending the first update bearer request to the wireless device start a timer. For example, the SMF+PGW-C may expect a response from the wireless device before the timer expires. For example, the timer may have a start value. For example, the timer may expire counting from the start value down to zero, from zero up to the start value and/or the like. For example, when the timer expires the SMF+PGW-C may resend the first update bearer request to the wireless device.

In an example, the SMF+PGW-C may resend the first update bearer request up to four times. For example, after four retransmissions, the SMF+PGW-C may consider NSSAA as failed. For example, the timer may be a T3575 timer and/or the like.

In an example, the SMF+PGW-C may stop the timer based on receiving a first update bearer response.

In an example, the SMF+PGW-C may send the first update bearer request in response to receiving the first Nnssaaf_NSSAA_Authenticate response message.

In an example, the SMF+PGW-C may send the first update bearer request to the SGW. For example, the first update bearer request may comprise the third PCO information element.

In an example, the SMF+PGW-C sends the first update bearer request in a first general packet radio service (GPRS) tunneling protocol version 2 control plane (GTPv2-C) message to the MME.

In an example, the SGW may receive the first update bearer request. For example, the SGW may receive the first update bearer request from the SMF+PGW-C.

In an example, the SGW may send the first update bearer request to the MME. For example, the SGW may send the first update bearer request in a second GTPv2-C message to the MME.

In an example, the MME may receive the first update bearer request. For example, the MME may receive the first update bearer request from the SGW.

In an example, the MME may send the third PCO information element from the first update bearer request to the wireless device in a downlink NAS transport message via the base station.

In an example, the MME may build a session management request message. For example, the session management request message may comprise the third PCO information element. For example, the downlink NAS transport message may be a session management configuration message. For example, the session management configuration message may comprise the session management request message.

In an example, the base station may receive the downlink NAS transport message from the MME.

In an example, the base station may send the downlink NAS transport message to the wireless device. For example, the base station may send the session management request message to the wireless device in a first direct transfer message. For example, the first direct transfer message may be an RRC message carrying the session management request message.

In an example, the wireless device may receive third PCO information element. For example, the wireless device may retrieve the third PCO information element from the downlink NAS transport message.

In an example, the wireless device may generate a response message based on receiving the downlink NAS transport message. For example, the wireless device may based on the contents of the first EAP message generate a response. For example, the response may be used by the AAA-S to verify the identity of the wireless device. For example, after verifying the identity of the wireless device the AAA-S may based on local configuration determine if the wireless device is authorized to access the slice associated with the S-NSSAI.

In an example, the wireless device may build a session management response message. For example, the session management response message may comprise a fourth PCO information element. For example, the fourth PCO information element may comprise a second EAP message (second EAP msg) and the S-NSSAI. For example, the second EAP message may comprise of the response.

In an example, the wireless device may send the session management response message to the base station in a second direct transfer message.

In an example, the base station may send the session management response message to the MME in a NAS uplink transport message.

In an example, the wireless device may send the uplink NAS transport message to the MME via the base station.

In an example, the MME may receive the uplink NAS transport message. For example, the MME may receive the uplink NAS transport message from the base station.

In an example, the MME may send the first update bearer response message (first update bearer resp) to the SGW. For example, the first update bearer response message may comprise the fourth PCO information element.

In an example, the MME may send the first update bearer response in a third GTPv2-C message to the SGW.

In an example, the SGW may send the first update bearer response message to the SMF+PGW-C.

In an example, the SWG may send the first update bearer response in a fourth GTPv2-C message to the SMF+PGW-C.

In an example, the SMF+PGW-C may receive the first update bearer response message. For example, the SMF+PGW-C may receive the first update bearer response message from the SGW.

In an example the SMF+PGW-C may send a second Nnssaaf_NSSAA_Authenticate request message to the NSSAAF. For example, the second Nnssaaf_NSSAA_Authenticate request message may comprise the GPSI, the second EAP message, the S-NSSAI and/or the like.

In an example, the NSSAAF may receive the second Nnssaaf_NSSAA_Authenticate request message. In an example, the NSSAAF may convert the second Nnssaaf_NSSAA_Authenticate request message to a third AAA protocol message.

In an example, the NSSAAF may send the third AAA protocol message to the AAA-S. For example, the third AAA protocol message may comprise the second EAP message, the GPSI, the S-NSSAI and/or the like.

In an example, the AAA-S may send a fourth AAA protocol message to the NSSAAF. For example, the fourth AAA protocol message may comprise an EAP result, the GPSI, the S-NSSAI and/or the like. For example, the EAP result may indicate success or failure of the NSSAA. For example, an EAP-Success may indicate the NSSAA was successful. For example, an EAP-Failure may indicate the NSSAA was unsuccessful.

In an example, the NSSAAF may receive the fourth AAA protocol message from the AAA-S. In an example, the NSSAAF may convert the fourth AAA protocol message into a second Nnssaaf_NSSAA_Authenticate response message (second Nnssaaf_NSSAA_authenticate Resp). For example, the second Nnssaaf_NSSAA_Authenticate response message may comprise the EAP result, the GPSI and the S-NSSAI.

In an example, the NSSAAF may send the second Nnssaaf_NSSAA_Authenticate response message to the SMF+PGW-C.

In an example, the SMF+PGW-C may receive the second Nnssaaf_NSSAA_Authenticate response message. For example, the SMF+PGW-C may receive the second Nnssaaf_NSSAA_Authenticate response message from the NSSAAF.

In an example, the SMF+PGW-C may determine an action based on the EAP result. In an example, the EAP result may indicate success. For example, if the result indicates success the SMF+PGW-C may update the N4 rules to uplink data is ALLOWED or the like. For example, uplink data is ALLOWED may indicate the wireless device may send data over the PDN connection associated with the S-NSSAI, the wireless device has successfully performed NSSAA and/or the like.

In an example, the EAP result may indicate failure. For example, the SMF+PGW-C may in response to the failure refrain from updating the N4 rules and retain the uplink data is not allowed state, trigger a new NSSAA and/or the like.

In an example, the SMF+PGW-C may send a second update bearer request message (second update bearer request) to the SGW. For example, sending the second update bearer request message to the wireless device may be based on a bearer modification without QoS update procedure and/or the like. For example, the update bearer request may comprise the EAP result, the S-NSSAI, an indication uplink data is allowed and/or the like. For example, the EAP result, the S-NSSAI, the indication uplink data is allowed may be encoded into a fifth PCO information element and/or the like.

In an example, the SMF+PGW-C may send the second update bearer request message in a fifth GTPv2-C message to the SGW.

In an example, the SGW may receive the second update bearer request message.

In an example, the SGW may send the second update bearer request message to the MME.

In an example, the SGW may send the second update bearer request in a sixth GTPv2-C message to the MME.

In an example, the MME may send the fifth PCO information element in a second session management request message to the base station. For example, the second management request message may be sent in a second downlink NAS transport message (second downlink NAS transport).

In an example, the base station may receive the second session management request message. For example, the base station may receive the second session management request message from the MME. For example, the base station may receive the second session management request message in the second downlink NAS transport message from the MME.

In an example, the base station may send the second management request message to the wireless device. For example, the base station may send the second management request message to the wireless device in a second direct transfer message.

In an example, the indication uplink data is allowed may be interpreted by the wireless device as successful NSSAA. For example, the wireless device may interpret the indication uplink data is allowed as EAP-Success and/or the like. For example, the wireless device may understand the NSSAA was successful without the fifth information element comprising the EAP result.

In an example, the wireless device may add the S-NSSAI to an allowed NSSAI. For example, if the EAP result indicates success and/or the indication uplink data is allowed the wireless device may put/place/add the S-NSSAI to the allowed NSSAI and/or the like.

In an example, the wireless device may add the S-NSSAI to a rejected NSSAI. For example, if the EAP result indicates failure, the wireless device may put/place/add the S-NSSAI to the rejected NSSAI and/or the like.

In an example, not depicted, the wireless device may send a PDN disconnection request to the MME. For example, the purpose of the PDN disconnection request may be to remove the PDN connection. For example, the EAP result may indicate failure and the wireless device may not be allowed to send data over the PDN connection. In order to avoid locking resources in response to an unsuccessful NSSAA, the SMF+PGW-C may include an instruction for the wireless device to send the PDN disconnection request for the PDN connection in the update bearer request and/or the like. For example, the wireless device may send the PDN disconnection request based on receiving the EAP result and/or receiving an indication of NSSAA failure in the second update bearer request and/or not receiving the indication uplink data is allowed for the PDN connection and/or the like.

The proposed embodiment may provide signaling to decrease delay of services when the wireless device is interworking between the EPS and the 5GS.

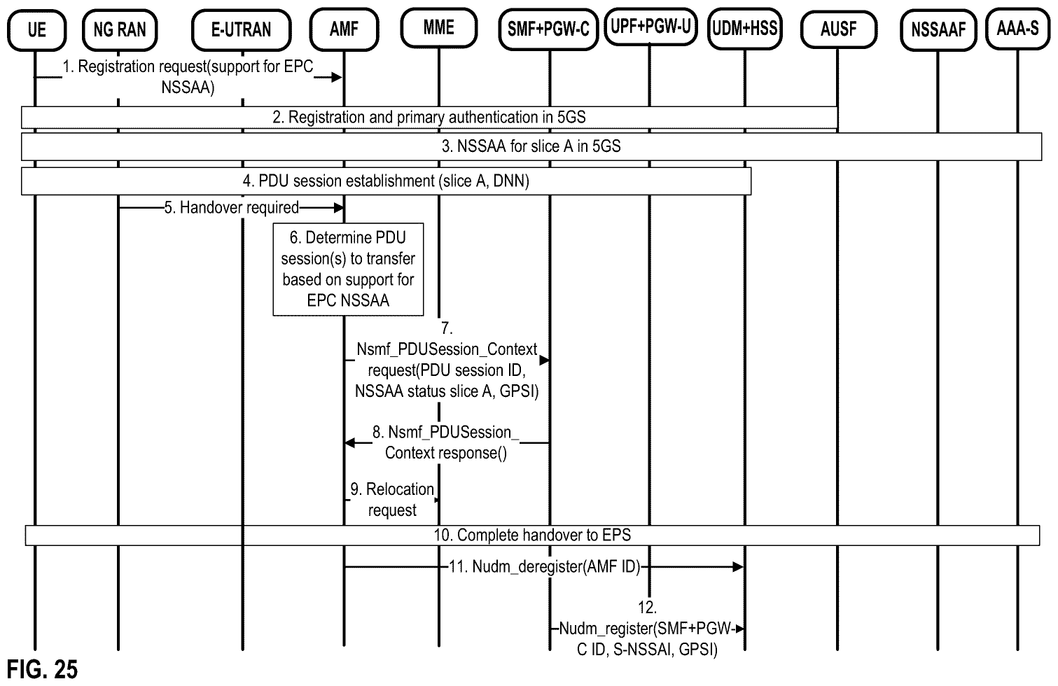

FIG. 25 may depict one example embodiment of the present disclosure. In an example, a wireless device (UE) may be sent from a 5GS to an EPS.

In an example, the wireless device may send a registration request to the 5GS. For example, the wireless device may send the registration request to an AMF. For example, the AMF may be associated with the 5GS. For example, the wireless device may send the registration request via a first base station (next generation radio access network (NG RAN)).

In an example, the registration request may comprise an indication of support for EPC NSSAA, an identifier for a slice A and/or the like. For example, support for EPC NSSAA may refer to support for NSSAA over EPC, support for slice specific authentication via EPS, support for slice authentication via EPC, support for NSSAA over 3GPP access to EPC and/or the like.

In an example, the indication of support for EPC NSSAA may be encoded as an element in a 5GMM capability information element. For example, the support for EPC NSSAA may be encoded as a capability. For example, the capability may be encoded as a bit in the 5GMM capability information element. For example, the bit may be 1 based on the wireless device supporting EPC NSSAA. For example, the bit may be 0, based on the wireless device not supporting EPC NSSAA.

In an example, the indication of support for EPC NSSAA may be encoded as an element in a 5GSM capability information element. For example, the support for EPC NSSAA may be encoded as the capability. For example, the capability may be encoded as a bit in the 5GSM capability information element. For example, the bit may be 1 based on the wireless device supporting EPC NSSAA. For example, the bit may be 0, based on the wireless device not supporting EPC NSSAA.

In an example, the registration request may be a NAS message. In an example, the registration request may comprise the 5GMM capability information element.

In an example, the AMF may receive the registration request. For example, the AMF may based on a type of registration request, a local AMF policy, availability of a security context for the wireless device determine to trigger a run of primary authentication for the wireless device. For example, if the registration request is an initial registration type, the AMF may trigger the run of primary authentication for the wireless device. For example, the local AMF policy may determine to authenticate the wireless device within an time interval, after an amount of registration requests, the wireless device moving from a location and/or the like. For example, the AMF may not have the security context for the wireless device and determine to run the primary authentication for the wireless device.

In an example, the AMF may send a registration accept message to the wireless device, send a NAS security mode command message to the wireless device and/or the like.

In an example, the identifier for the slice A may be an S-NSSAI. For example, the slice A may require NSSAA (slice authentication) before the wireless device may use services associated with the slice A.

In an example, the AMF may trigger NSSAA for the wireless device associated with the slice A. For example, upon successful completion of the NSSAA the AMF may send a UE configuration update message to the wireless device indicating successful NSSAA for the slice A.

In an example, the wireless device may put the slice A in an allowed NSSAI. For example, based on receiving the configuration update message indicating successful NSSAA for the slice A. For example, the wireless device may put the S-NSSAI in the allowed NSSAI.

In an example, the wireless device may send a PDU session establishment request for a PDU session to the 5GS. For example, the PDU session establishment request may comprise the slice A, a DNN, the 5GSM capability information element and/or the like. For example, the DNN may be mapped to an APN in EPS. For example, mapped may refer to the DNN being identified by the APN.

In an example, a SMF+PGW-C may receive the PDU session establishment request.

In an example, the SMF+PGW-C may send a PDU session accept message to the wireless device. For example, the PDU session may be established. For example, established may refer to the PDU session being able to transfer data to/from the wireless device.

In an example, the first base station may determine there is a need to hand over the wireless device to a second base station (E-UTRAN). For example, the first base station may determine to hand over the wireless device based on workload in the first base station, radio conditions and/or the like.

In an example, the first base station may send a handover required message to the AMF. For example, the handover required message may be an NGAP message.

In an example, the AMF may determine which PDU session(s) can be transferred to the EPS. For example, PDU sessions associated with a slice that requires NSSAA e.g., slice A may be transferred to the EPS based on the support for EPC NSSAA. For example, if the wireless device supports EPC NSSAA, the PDU session may be moved to the EPS. For example, the AMF may have local rules on which slices allow for moving PDU sessions to the EPS. For example, the slice A may allow moving the PDU session associated with the slice A to EPS during interworking whilst another slice requiring NSSAA may not allow moving PDU sessions to be moved to EPS during interworking.

In an example, the AMF may determine which PDU session(s) can be transferred to the EPS based on the 5GMM capability information element. For example, the AMF may allow transfer of PDU session(s) per slice. For example, the AMF may determine to allow transfer of the PDU session associated with the slice A. For example, the AMF may determine to allow the transfer of the PDU session based on the wireless device supporting EPC NSSAA. For example, the AMF may determine the wireless device supports EPC based on the 5GMM capability information element comprising the bit indicating the wireless device supporting EPC NSSAA.

In an example, the AMF may have a session management context (SM context) for the PDU session. For example, the SM context may comprise a mapped EPS bearer context. For example, the mapped EPS bearer context may comprise the indication of support for EPC NSSAA. For example, by including the indication of support for EPC NSSAA in the mapped EPS bearer context, the AMF may use the information to determine if the PDU session can be moved to the EPS.

In an example, the AMF may determine to transfer the PDU session to the EPS.

In an example, the PDU session may be a PDN connection whilst in the EPS.

In an example, the AMF may send a Nsmf_PDUsession_Context request to the SMF+PGW-C. For example, the Nsmf_PDUsession_Context request may comprise an ID of the PDU session (PDU session ID), a GPSI, an NSSAA status for the slice A. For example, an MME of the EPS may not be aware of slices, therefore the AMF may send information to the SMF+PGW-C to be able to handle NSSAA whilst the wireless device is in EPS. For example, the responsibility to handle NSSAA may move from the AMF to the SMF+PGW-C during interworking with the EPS. For example, if PDU sessions are handled by multiple SMF+PGW-C(s), the responsibility for NSSAA may be decentralized. For example, decentralized may mean the responsibility for NSSAA is spread out among several network nodes e.g., SMF+PGW-Cs.

For example, the GPSI may be used during NSSAA (slice authentication), slice reauthentication triggered by a AAA-S and/or the like. For example, if the GPSI is not sent to the SMF+PGW-C, the SMF+PGW-C may not be able to trigger NSSAA for the wireless device.

In an example, the wireless device may have a subscription which may be identified by more than the GPSI. For example, the SMF+PGW-C may send a request to an UDM+HSS for the GPSI and may receive the GPSI or a second GPSI in a response. For example, the AAA-S may be unaware of the second GPSI and attempt to trigger slice reauthentication with the GPSI.

In an example, the NSSAA status for the slice A may be used to indicate if the SMF+PGW-C may allow user traffic directly on an EPS bearer mapped from the PDU session or the SMF+PGW-C may need to trigger NSSAA in EPS first before allowing traffic on the EPS bearer. For example, if the NSSAA status indicates a valid authentication for the slice A user traffic may be allowed directly. For example, the NSSAA status may be an NSSAA result. For example, the NSSAA result may be EAP-Success, EAP-Failure and/or the like. For example, the NSSAA status may have an associated timer. For example, the timer may have a timer value indicating a duration for how long the NSSAA status is valid.

In an example, the AMF may set the timer value at handover from the 5GS to the EPS. For example, the AMF may set the timer value to avoid NSSAA for multiple PDN connections simultaneously. For example, if NSSAA is required for several slices after handover to the EPS, a first PDN connection associated with the slice A may perform NSSAA. For example, simultaneously a second PDN connection associated with a slice B requiring NSSAA may also need to perform NSSAA. For example, the second PDN connection may have to wait to perform NSSAA until NSSAA for the first PDN connection is done.

In an example, not depicted, the AMF may send the GPSI and/or the NSSAA status for the slice A and/or the PDU session ID in an Nsmf_PDUSession_UpdateSMContext request. For example, the AMF may send the Nsmf_PDUSession_UpdateSMContext request to the SMF+PGW-C.

In an example, the SMF+PGW-C may send a Nsmf_PDUSession_Context_response message to the AMF.

In an example, the AMF may receive a Nsmf_PDUSession_Context_response from the SMF+PGW-C comprising a mapped EPS PDN connection for the PDU session.

In an example, the AMF may send a relocation request to the MME.

In an example, the network may reconfigure the PDU session from the 5GS to the EPS. For example, moving connection points. For example, the PDU session may have a tunnel from the first base station to a UPF. For example, the tunnel may be moved to have connection points between the second base station and the PGW-U, the wireless device may receive a handover command and start communicating with the second base station and/or the like.

In an example, the AMF may send a Nudm_deregister message to the UDM. For example, the AMF may send the Nudm_deregister message in response to a successful handover to EPS. For example, the Nudm_deregister message may be sent due to the AMF no longer serving the wireless device.

In an example, the SMF+PGW-C may register in the UDM+HSS. For example, the SMF+PGW-C may register with the UDM+HSS as a network function serving the wireless device for the slice A. For example, the AMF may serve the wireless device with multiple slices and be a central communication point for handing NSSAA in the 5GS. For example, in the EPS, NSSAA functionality may be handled by the SMF+PGW-C and optionally additional SMF+PGW-C(s). For example, during interworking between the 5GS and the EPS several SMF+PGW-C(s) may be used.

In an example, the SMF+PGW-C may send a Nudm_register message to the UDM+HSS. In an example, the Nudm_register message may comprise an identity (ID) of the SMF+PGW-C (SMF+PGW-C ID), the S-NSSAI associated with the slice A, the GPSI, a permanent identifier of the wireless device and/or the like. For example, the permanent identifier may be an IMSI, a SUPI and/or the like. For example, the SMF+PGW-C may send the Nudm_register message in response to establishing PDN connectivity for the PDN connection associated with the slice A requiring NSSAA.

The proposed embodiment may provide signaling to decrease delay of services when the wireless device is interworking between the 5GS and the EPS.

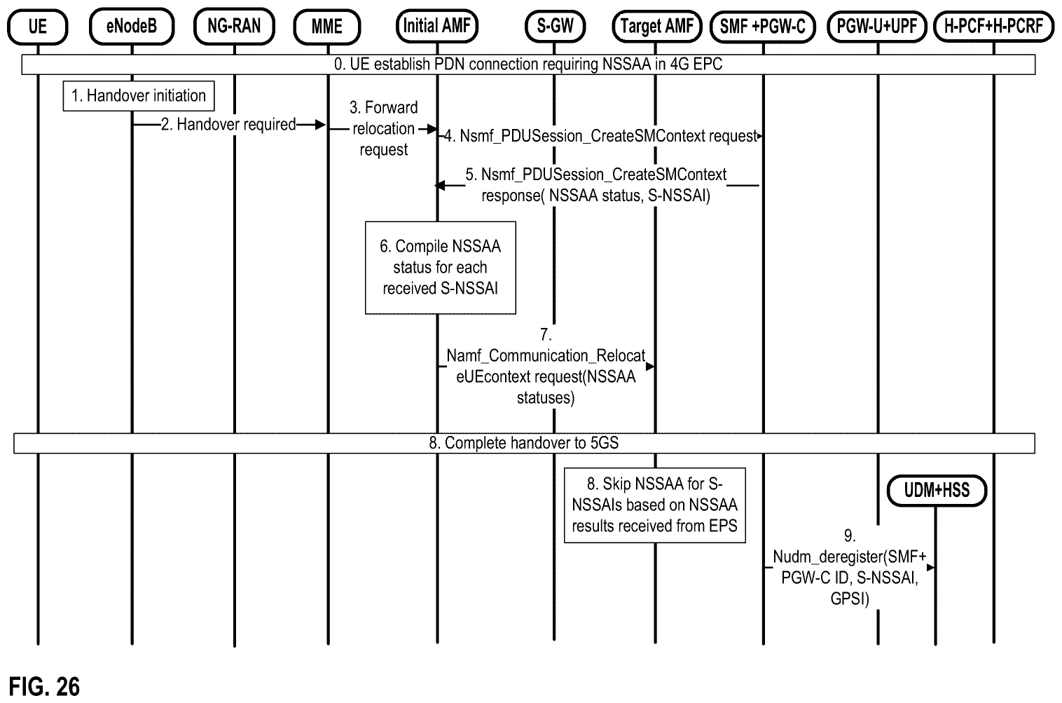

FIG. 26 may depict one example embodiment of the present disclosure. In an example, a wireless device (UE) may be sent from an EPS to a 5GS.

Similar to FIG. 21, the wireless device may move from the EPS to the 5GS. For example, move may imply the wireless device is served by an EPC and after moving, the wireless device is served by a 5GC. For brevity, based on the other part of the present disclosure, redundant details will be omitted. Reverting back to FIG. 26.

In an example, the wireless device may have established a PDN connection in the EPS (EPC). For example, the PDN connection may be established towards an APN associated with a slice. For example, the slice may require NSSAA.

In an example, the wireless device may have performed NSSAA in EPC to establish the PDN connection towards the APN.

In an example, an eNodeB of the EPS may determine to handover the wireless device to an NG-RAN (the 5GS). For example, the eNodeB may determine to handover the wireless device based on radio conditions, load of the eNodeB and/or the like.

In an example, the eNodeB may send to an MME, a handover required message. For example, the handover required message may indicate the target node e.g., the NG-RAN.

In an example, the MME may send a forward relocation request to an initial AMF. For example, the forward relocation request may comprise an EPS mobility management context, a list of a PDN connection(s) and their corresponding SMF+PGW-C. For example, corresponding SMF+PGW-C may refer to a SMF+PGW-C handing the PDN connection. For example, the EPS mobility management context may comprise an indication of NSSAA support over EPC.

In an example, the initial AMF may convert the EPS mobility management context to a 5GS mobility management context. For example, the initial AMF may move/copy/add to the 5GS mobility management context the indication of NSSAA support over EPC.

In an example, the initial AMF may send a Nsmf_PDUSesstion_CreateSMContext request to an SMF+PGW-C. For example, the Nsmf_PDUSession_CreateSMContext request may comprise an identifier of the PDN connection. For example, the initial AMF may have received the identifier of the PDN connection and/or the SMF+PGW-C in the forward relocation request.

In an example, the SMF of the SMF+PGW-C finds a corresponding PDU session to the PDN connection based on an EPS bearer context.

In an example, the SMF+PGW-C may send a Nsmf_PDUSession_CreateSMContext response to the initial AMF. For example, the Nsmf_PDUSession_CreateSMContext response may comprise a PDU session ID, a S-NSSAI, an NSSAA status for the S-NSSAI and/or the like. For example, the NSSAA status may indicate if the wireless device has successfully performed NSSAA for the slice, if the wireless device has successfully performed NSSAA in the EPS/EPC, if the NSSAA status was transferred from the 5GS, if the NSSAA status may be transferred to the 5GS and/or the like.

In an example, the SMF of the SMF+PGW-C may determine that seamless session continuity from the EPS to the 5GS is not supported for the PDU session. For example, in response to determining seamless continuity from the EPS to the 5GS is not supported the SMF may omit the PDU session ID from the Nsmf_PDUSession_CreateSMContext response.

In an example, the initial AMF may receive the Nsmf_PDUSession_CreateSMContext response. For example, the initial AMF may compile NSSAA status for each received S-NSSAI. For example, the initial AMF may send multiple Nsmf_PDUSession_CreateSMContext request messages to different SMFs and receive one or several NSSAA statuses. For example, the initial AMF may compile an allowed NSSAI for the wireless device based on information from Nsmf_PDUSession_CreateSMContext response(s).

In an example, the initial AMF may send a Namf_Communication_RelocateUEContext request to a target AMF. For example, the Namf_Communication_RelocateUEContext request may comprise an NSSAA statuses. For example, the NSSAA statues may be the allowed NSSAI, a list of NSSAA statuses and corresponding S-NSSAI and/or the like, encoded as part of the 5GS MM context and/or the like.

In an example, the handover procedure may continue to move the PDN connection from the EPS to the 5GS.

In an example, the network may reconfigure the PDN connection from the EPS to the 5GS. For example, moving connection points. For example, the PDN connection may have a tunnel from the eNodeB to a PGW-U. For example, the tunnel may be moved to have connection points between the NG-RAN and the UPF, the wireless device may receive a handover command and start communicating with the NG-RAN and/or the like.

In an example, the wireless device may in response to receiving the handover command retain an allowed NSSAI. For example, the allowed NSSAI may comprise S-NSSAI(s) of which the wireless device has successfully performed NSSAA in EPS.

In an example, the target AMF may have stored the NSSAA statues in a UE context of the wireless device.

In an example, the PDU session may have been transferred from the EPS to 5GS with seamless session continuity. For example, based on including the NSSAA status for the S-NSSAI associated with the PDN connection converted into the PDU session at handover, the wireless device may avoid service interruption.

In an example, the wireless device may request a second PDU session in the 5GS after handover from the EPS. For example, the second PDU session may be associated with a second slice requiring NSSAA. For example, during handover it may have been determined seamless session continuity was not possible for a second PDN connection associated with the second slice. For example, due to including an NSSAA status of the second slice during handover the wireless device may request the second PDU session without additional signaling to perform NSSAA for the second slice before requesting the second PDU session.

In an example, the SMF+PGW-C may after successful handover to 5GS deregister from the UDM as a serving network node for the slice. For example, the serving network node may refer to the serving network node handling NSSAA for the wireless device. For example, the SMF+PGW-C may send a Nudm_deregister message to a UDM+HSS. The Nudm_deregister message may comprise an SMF+PGW-C ID, the S-NSSAI, the GPSI, a permanent identifier of the wireless device and/or the like.

For example, in EPS multiple serving nodes may be needed to handle NSSAA whilst in 5GS one serving node can handle NSSAA for the wireless device. For example, moving from the 5GS to the EPS may require a responsibility for NSSAA to be delegated from the AMF to one or several SMF+PGW-C(s). For example, moving from the EPS from the 5GS may require the responsibility of NSSAA to be moved back from one or several SMF+PGW-C(s) to the AMF.

The proposed embodiment may provide signaling to decrease delay of services when the wireless device is interworking between the EPS and the 5GS.

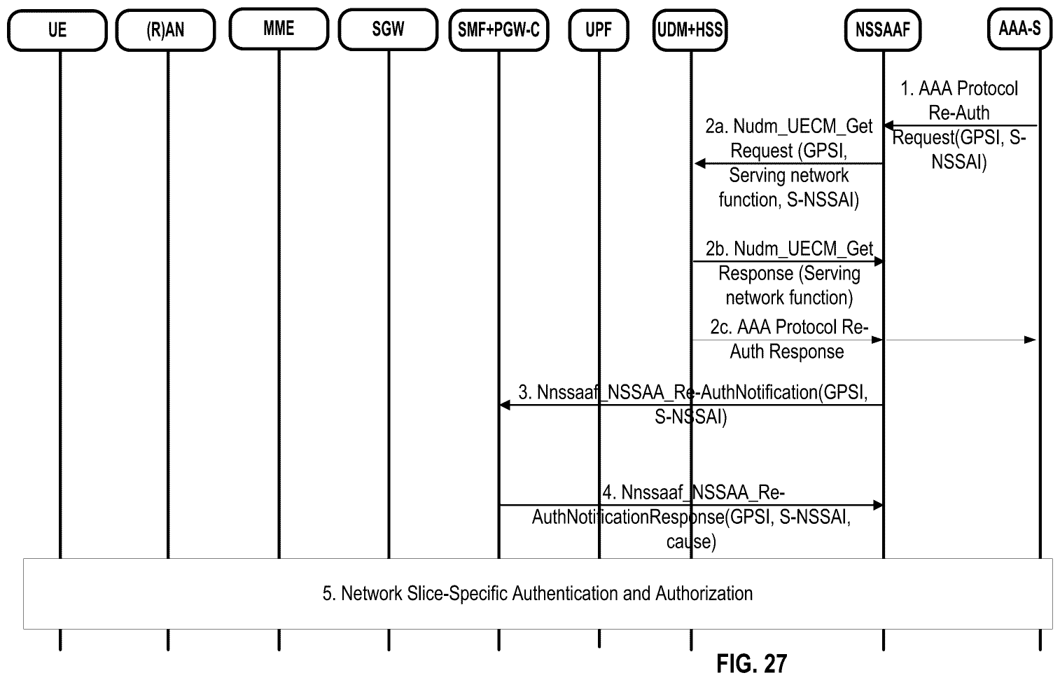

FIG. 27 may depict one example embodiment of the present disclosure. In an example, a AAA-S may want to reauthenticate a wireless device (UE) for a slice (S-NSSAI).

In an example, the AAA-S may send a AAA protocol re-auth request to a NSSAAF. For example, the AAA protocol re-auth request may comprise the S-NSSAI, a GPSI, an authentication instruction and/or the like

In an example, the authentication instruction may indicate NSSAA should be performed immediately upon reception of the request to reauthenticate the wireless device, when the wireless device is handed over from a EPS to a 5GS, when the wireless device is handed over from the 5GS to the EPS and/or the like.

In an example, the NSSAAF may receive the AAA protocol re-auth request from the AAA-S.

In an example, the NSSAAF may send a Nudm_UECM_Get request to a UDM+HSS. For example, the Nudm_UECM_Get request may comprise the GPSI, a serving network function, the S-NSSAI. For example, the NSSAAF may include the serving network function to receive an address to the serving network function.

For example, the serving network function may refer to an AMF if the wireless device is registered with the 5GS. For example, the AMF handles slice security e.g., NSSAA in the 5GS. For example, the serving network function may refer to a SMF+PGW-C when the wireless device is registered with the EPS.

In an example, the NSSAAF may include the S-NSSAI to find the SMF+PGW-C serving the wireless device with a PDN connection associated with the slice.

In an example, not depicted, the AMF may be the serving network function for the wireless device in the EPS. For example, the AMF may work as a relay towards the SMF+PGW-C. For example, the AMF may handle NSSAA aspects when the wireless device is in the EPS e.g., during interworking.

In an example, the UDM+HSS may return the address to the SMF+PGW-C to the NSSAAF in a Nudm_UECM_Get Response. For example, the UDM+HSS may based on the GPSI and/or S-NSSAI locate the address of the SMF+PGW-C. For example, the GPSI may map to a permanent identifier of the wireless device. For example, the permanent identifier may be an IMSI, a SUPI and/or the like.

In an example, the NSSAAF may send a AAA protocol re-auth response to the AAA-S. For example, the AAA protocol re-auth response may be sent as an acknowledgement the NSSAAF have found the serving network function.

In an example, the NSSAAF may send a Nnssaaf_NSSAA_Re-AuthNotification to the SMF+PGW-C. For example, the Nnssaaf_NSSAA_Re-AuthNotification may comprise the GPSI, the S-NSSAI, the authentication instruction and/or the like.

In an example, the SMF+PGW-C may trigger NSSAA of the wireless device for the slice associated with the S-NSSAI.

In an example, the SMF+PGW-C may set a pendinginterworkingNSSAA flag based on the authentication instruction. For example, the authentication instruction may indicate NSSAA is required at handover from the EPS to the 5GS for the slice. For example, the pendinginterworkingNSSAA flag may be sent to an AMF during handover from the EPS to the 5GS. For example, the inclusion of the pendinginterworkingNSSAA flag may cause the AMF to trigger NSSAA for the slice.

In an example, the pendinginterworkingNSSAA flag may be set to trigger NSSAA when the wireless device request PDN connectivity associated with the slice. For example, the PDN connection may no longer be active when the AAA-S triggers re-authentication.

In an example, the SMF+PGW-C may receive from an MME an indication the wireless device is unreachable.

In an example, the SMF+PGW-C may send a service based message to the NSSAAF. For example, the service based message may be a Nnssaaf_NSSAA_Re-AuthNotificationResponse. The Nnssaaf_NSSAA_Re-AuthNotificationResponse may comprise the GPSI, the S-NSSAI, a cause. For example, the cause may indicate the wireless device was not reachable, the wireless device was not reachable and NSSAA may be triggered when the wireless device is handed over to the 5GS, the wireless device was not reachable and the SMF+PGW-C may reattempt to trigger the NSSAA for the wireless device within a timeframe, the wireless device was not reachable and the SMF+PGW-C may reattempt to trigger the NSSAA for the wireless device at reception of a next PDN connectivity request from the wireless device and/or the like.

In an example, the NSSAAF may send the cause to the AAA-S in the AAA Protocol re-auth or send a separate AAA protocol message comprising the cause.

In an example, the AAA-S may receive the cause in the AAA protocol re-auth and/or the separate AAA protocol message.

In an example, the AAA-S may based on the cause determine an action. For example, if the cause indicates it was not possible to trigger NSSAA for the wireless device, the AAA-S may revoke authorization for the wireless device to use the slice.

In an example, the cause may indicate NSSAA is to be performed when the wireless device is handed over from the EPS to the 5GS. For example, based on the cause, the AAA-S may determine to allow the wireless device to continue use the slice for some time. For example, the AAA-S may revoke the authorization for the wireless device to use the slice based on a timer. For example, if the wireless device is handed over to the 5GS and NSSAA is triggered before the timer expires/runs out of time/ends the wireless device remains authorized to use the slice. For example, if the timer expires without NSSAA being triggered, the AAA-S may revoke the authorization for the wireless device to use the slice.

In an example, revoke may refer to a PDN connection associated with the slice is released.

The proposed embodiment may provide signaling to support slice reauthentication when the wireless device is interworking in the EPS.

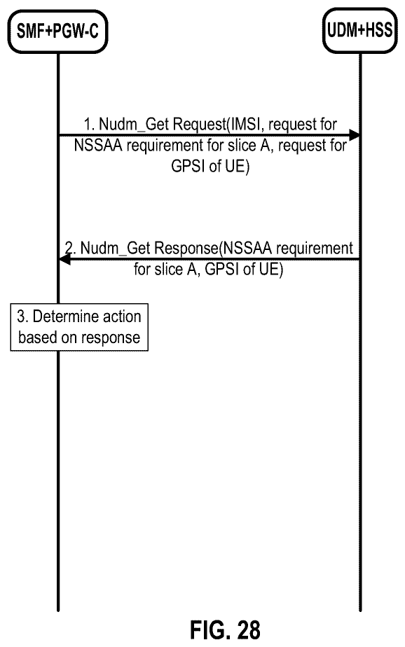

FIG. 28 may depict one example embodiment of the present disclosure. In an example, a SMF+PGW-C may need information about an NSSAA requirement for a slice A. For example, the SMF+PGW-C may need to know if there is a need to trigger NSSAA. For example, the SMF+PGW-C may receive a PDN connectivity request for an APN associated with the slice A. For example, the SMF+PGW-C may not be aware of if the slice A requires NSSAA.

In an example, the SMF+PGW-C may send a Nudm_Get request to a UDM+HSS. For example, the Nudm_Get request may comprise an IMSI of a wireless device, a request for a NSSAA requirement for the slice A, a request for a GPSI of the wireless device and/or the like. For example, the UDM+HSS may locate a subscription data for the wireless device based on the IMSI. For example, the subscription data may comprise the GPSI of the wireless device, the NSSAA requirement for the slice A.

In an example, the NSSAA requirement for the slice A may be per S-NSSAI.

In an example, the NSSAA requirement may indicate the slice A requires NSSAA, the slice A does not require NSSAA, the slice A does not allow for NSSAA in an EPS/over EPC and/or the like.

In an example, the UDM+HSS may send a Nudm_Get response to the SMF+PGW-C. For example, the Nudm_Get response may comprise the NSSAA requirement, the GPSI of the wireless device and/or the like.

In an example, the SMF+PGW-C may determine an action based on the Nudm_Get response. For example, if the NSSAA requirement indicates the slice A does not require NSSAA, the SMF+PGW-C may establish a PDN connection associated with the slice A without triggering NSSAA.

In an example, the SMF+PGW-C may determine an action based on the Nudm_Get response. For example, if the NSSAA requirement indicates the slice A requires NSSAA, the SMF+PGW-C may trigger NSSAA for the slice A. For example, the SMF+PGW-C may use the GPSI during NSSAA.

In an example, the SMF+PGW-C may determine an action based on the Nudm_Get response. For example, if the NSSAA requirement indicates the slice A does not allow for NSSAA in EPS, the SMF+PGW-C may reject the PDN connection, reject the PDN connection if there is no a NSSAA status available in the SMF+PGW-C for the slice A indicating success and/or the like. For example, the NSSAA status may have been transferred during an interworking procedure. For example, interworking procedure may refer to transfer from 5GS to EPS and/or the like.

The proposed embodiment may provide signaling to support slice authentication when the SMF+PGW-C is to handle NSSAA.

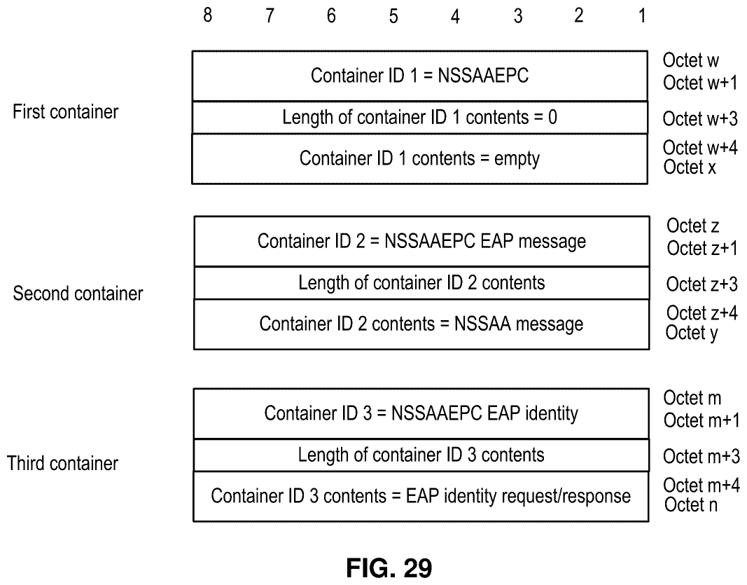

FIG. 29 may depict one example embodiment of the present disclosure. In an example, a PCO information element may comprise information to enable slice authentication (NSSAA) in an EPS. For example, the PCO information element may be an extended PCO information element.

In an example, the PCO information element may comprise of one or several containers carrying information related to slice authentication.

In an example, a first container may comprise of a container ID 1 field. For example, the container ID 1 field may be encoded to indicate NSSAA in EPC/EPS. For example, the container ID 1 may be encoded to NSSAAEPC, NSSAAEPS, EPCNSSAA, EPSNSSAA and/or the like. For example, encoded may refer to the container ID 1 field comprising a string indicating NSSAA in EPS/EPS.

In an example, a container ID 1 contents field of the first container may be empty.

In an example, a second container may comprise a container ID 2 field. For example, the container ID 2 field may indicate NSSAAEPC EAP message. For example, the container ID 2 field may be encoded to NSSAAEPC EAP message. For example, EAP messages may be used with other features in the EPS, clarifying NSSAA may aid a wireless device to understand an EAP message is related to NSSAA. For example, encoded may refer to the container ID 2 field comprising a second string indicating NSSAAEPC EAP message.

In an example, a container ID 2 contents field may comprise an NSSAA message. For example, the NSSAA message may be the EAP message. For example, if the NSSAA message is sent from the EPS to the wireless device, the NSSAA message may be a network slice-specific authentication command message, a network slice-specific authentication result and/or the like.

For example, if the NSSAA message is sent from the wireless device to the EPS, the NSSAA message may be a network slice-specific authentication complete message.

In an example, the PCO information element may comprise a third container. For example, the third container may comprise a container ID 3 field. For example, the container ID 3 field may be encoded to indicate NSSAAEPC EAP identity. For example, NSSAAEPC EAP identity may imply the third container comprises a request for an EAP identity or a response with the EAP identity. For example, the request for the EAP identity or the response with the EAP identity may be encoded into a container ID 3 contents field. For example, encoding may refer to adding a string or adding binary data to a field.

The proposed embodiment may provide information elements to support slice authentication when the wireless device is interworking in the EPS.

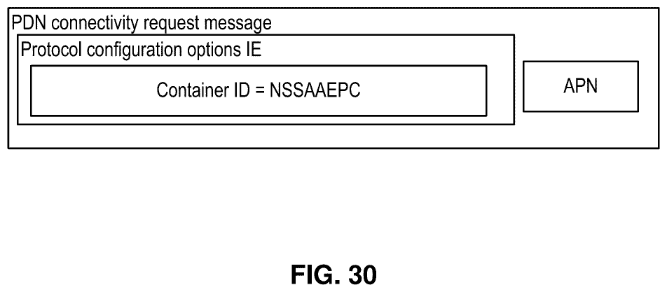

FIG. 30 may depict one example embodiment of the present disclosure. In an example, a PDN connectivity request message may comprise information about support for NSSAA in an EPC.

In an example, the PDN connectivity request message may comprise a protocol configuration options information element (IE).

In an example, the protocol configuration options IE may comprise a container. For example, the container may have a container ID encoded to indicate a wireless device sending the PDN connectivity request is capable of performing slice authentication (NSSAA) in EPC and/or EPS. For example, the container ID may be encoded to NSSAAEPC, NSSAAEPS and/or the like. For example, encoded may refer to adding a values as a string, hexadecimal values, binary data and/or the like.

In an example, the PDN connection request message may comprise the protocol configuration options IE and an APN. For example, the APN may be associated with a slice requiring slice authentication.

In an example, the wireless device may send the PDN connectivity request message to a network node in the EPC. For example, the network node may determine to trigger NSSAA based on the inclusion of support for NSSAA in the EPC.

The proposed embodiment may provide information elements to support slice authentication when the wireless device is registered in the EPS.

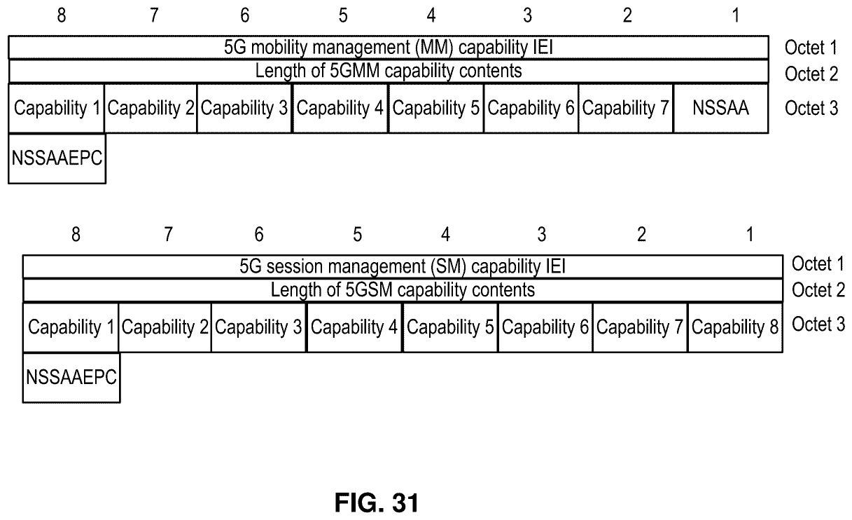

FIG. 31 may depict one example embodiment of the present disclosure. In an example, a wireless device may signal a support for network slice specific authentication and authorization (NSSAA) over EPC in a 5G mobility management (5GMM) capability information element identifier (IEI) and/or a 5G session management (5GSM) capability IEI.

In an example, the support for NSSAA over EPC may be encoded as a first bit in the 5GMM capability IEI and/or the 5GSM capability IEI. For example, if the first bit is 1 the first bit may indicate NSSAA over EPC is supported. For example, if the first bit is 0 the first bit may indicate NSSAA over EPC is not supported.

In an example, the 5GSM capability IEI may be included in a PDU session establishment request. For example, if the 5GSM capability IEI indicates support for NSSAA over EPC and the PDU session is associated with a slice that requires NSSAA may indicate the PDU session can be transferred to an EPS. For example, the PDU session may be transferred to the EPS during interworking.

In an example, the wireless device may send a registration request comprising the 5GMM capability to a 5GC. For example, the 5GC may use the indication for NSSAA over EPC to determine if an NSSAA result may be transferred to the EPC during interworking and/or the like. For example, the wireless device may indicate support for NSSAA over EPC, the 5GC may send the NSSAA result for a slice to the EPC during interworking.

In an example, the wireless device may send the registration request comprising the 5GMM capability to the 5GC. For example, the 5GC may use the indication for NSSAA over EPC to determine if an NSSAA result may be transferred to the EPC during interworking and/or the like. For example, the wireless device may indicate no support for NSSAA over EPC, the 5GC may determine to not send the NSSAA result for the slice to the EPC during interworking.

In an example, the 5GMM capability IEI may comprise a second bit indicating NSSAA. For example, indicating NSSAA may refer to a capability of performing NSSAA in the 5GC and does not provide guidance on handling of NSSAA during interworking.

The proposed embodiment may provide information elements to support slice authentication when the wireless device is interworking between EPS and 5GS.

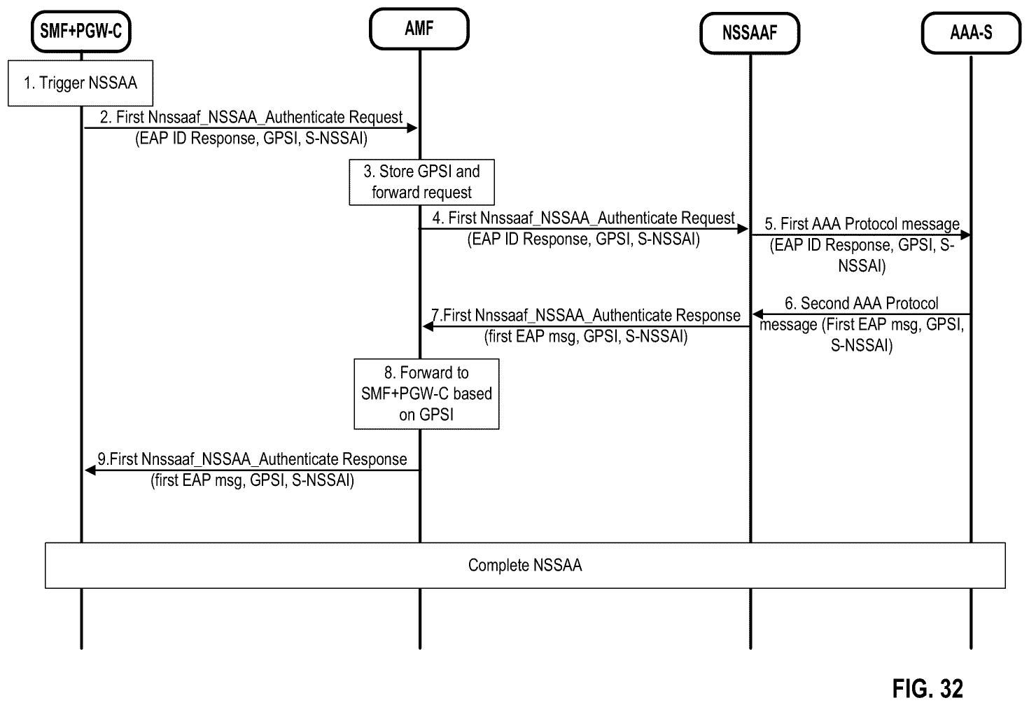

FIG. 32 may depict an example embodiment of the present disclosure. In an example, an SMF+PGW-C determines to trigger NSSAA and relays related messages via a 5GC.

In an example, the SMF+PGW-C may determine to trigger NSSAA. For example, based on a PDN connection being associated with a network slice of a 5GS. For example, the network slice may require NSSAA.

In an example, the SMF+PGW-C may send a first Nnssaaf_NSSAA_Authenticate Request. For example, the first Nnssaaf_NSSAA_Authenticate request may comprise an EAP ID Response, a GPSI, a S-NSSAI and or the like.

In an example, the SMF+PGW-C may send the first Nnssaaf_NSSAA_Authenticate Request to an AMF of the 5GC. For example, the SMF+PGW-C may send the first Nnssaaf_NSSAA_Authenticate Request over a service based interface. For example, the service based interface may be a N11 interface and/or the like.

In an example, the AMF may receive the first Nnssaaf_NSSAA_Authenticate Request from the SMF+PGW-C.

In an example, the AMF saves the GPSI locally from the first Nnssaaf_NSSAA_Authenticate Request. For example, the AMF saves the GPSI in a list associated with the SMF+PGW-C. For example, the AMF needs to know which request should be forwarded/relayed to the SMF+PGW-C and which request should be handled by the AMF. For example, handled by the AMF may refer to NSSAA triggered by the AMF or requests of NSSAA reauthentication for a one or more wireless devices served by the AMF.

In an example, the AMF relays/forwards/sends/routes the first Nnssaaf_NSSAA_Authenticate Request to a NSSAAF.

For example, the NSSAAF converts the first Nnssaaf_NSSAA_Authenticate Request into a first AAA protocol message. For example, the AAA protocol may be Radius, Diameter and/or the like.

In an example, the AAA-S sends a second AAA protocol message to the NSSAAF. For example, the second AAA protocol message may comprise a first EAP message (first EAP msg), the GPSI, the S-NSSAI and/or the like.

In an example, the NSSAAF translates/converts the second AAA protocol message to a service based message. For example, the service base message may be a first Nnssaaf_NSSAA_Authenticate response comprising the first EAP message, the GPSI, the S-NSSAI.

In an example, the NSSAAF sends the first Nnssaaf_NSSAA_Authenticate response to the AMF.

In an example, the AMF receives the first Nnssaaf_NSSAA_Authenticate response. For example, the AMF may based on the GPSI determine the AMF is currently not serving a wireless device corresponding to the GPSI. For example, the AMF may see if the AMF is currently relaying/forwarding/routing to an SMF+PGW-C based on the list associated with the SMF+PGW-C. For example, if the list comprises the GPSI, the AMF forwards the first Nnssaaf_NSSAA Authenticate response to the SMF+PGW-C. For example, the AMF may forward the first Nnssaaf_NSSAA_Authenticate response over the N11 interface.

In an example, the SMF+PGW-C may receive the first Nnssaaf_NSSAA_Authenticate response from the AMF over the N11 interface.

In an example, one or several messages related to NSSAA are relayed via the 5GC in order to complete the NSSAA.

In an example, the AMF may after handover for the wireless device from 5GS to the EPS, send a Nudm_deregistration message to a UDM+HSS. For example, the Nudm_deregistration message may comprise an indication the AMF may handle NSSAA for the wireless device, whilst the wireless device is in the EPS.

The proposed embodiment may provide signaling to support slice authentication when the UE is interworking between EPS and 5GS.

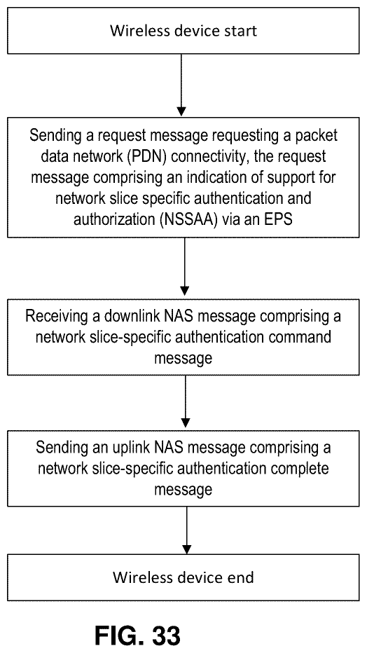

FIG. 33 may depict a flowchart for a wireless device.

In an example, the wireless device may send a request message requesting a packet data network (PDN) connectivity. For example, the request message may be a PDN connectivity request message and/or the like.

In an example, the request message may comprise an indication of support for network slice specific authentication and authorization via an EPS, an indication of support for network slice specific authentication and authorization over EPC, an indication of support for network slice specific authentication and authorization in EPC and/or the like.

In an example, the PDN connectivity may be associated with a network slice of a 5G system. For example, an APN of the PDN connectivity may be associated with the network slice and/or the like.

In an example, the indication of support for network slice specific authentication and authorization may be encoded into a first PCO information element. For example, the indication of support for network slice specific authentication and authorization may be encoded into a first container field of the first PCO information element.

In an example, the wireless device may send the request message to the EPS.

In an example, the wireless device may receive a downlink NAS message from the EPS. For example, the wireless device may receive the downlink NAS message in response to sending the request message.

In an example, the downlink NAS message may comprise a network slice-specific authentication command message. For example, the network slice-specific authentication command message may be encoded into a second PCO information element. For example, the second PCO element may comprise a second container field wherein the network slice-specific authentication command message is encoded. For example, encoded may refer to being represented as a string, as binary data, hexadecimal data and/or the like.

In an example, the wireless device may send an uplink NAS message comprising a network slice-specific authentication complete message and/or the like For example, the uplink NAS message may comprise a third PCO information element. For example, the third PCO information element may comprise a third container. For example, the network slice-specific authentication complete message may be encoded into the third container.

In an example, a user equipment (UE) (wireless device) may send a request message. For example, the UE may send the request message to a base station. For example, the base station may be associated with an evolved packet core (EPC). For example, the base station may be an eNodeB, gNb and/or the like. For example, the EPC may be part of an EPS. For example, the EPS may support interworking with a 5GS. For example, interworking may imply the UE can move from the EPS to the 5GS, from the 5GS to the EPS and/or the like. For example, a UE context of the UE may be transferred over a N26 interface when the UE is handed over from the 5GS to the EPS or vice versa. In an example, the N26 interface may use GTPv2-C messages for transferring of data.

In an example, the request message may be requesting a packet data network (PDN) connectivity (the request message requesting the PDN connectivity).

In an example, the request message may comprise an indication of support for network slice specific authentication and authorization (NSSAA) over the EPC (NSSAA over EPC). For example, the PDN connectivity may be associated with a network slice of the 5GS.

In an example, the PDN connectivity may be towards an APN. For example, the APN may be associated with the network slice.

In an example, the UE may receive a downlink NAS message. For example, the UE may receive the downlink NAS message from the base station.

In an example, the downlink NAS message may comprise a network slice-specific authentication command message for the network slice. For example, the UE may receive the network slice-specific authentication command message based on sending the request message requesting the PDN connectivity. For example, the PDN connectivity may be associated with the network slice. For example, the network slice may require slice authentication (NSSAA) before the UE may use the PDN connectivity.

In an example, the UE may send an uplink NAS message. For example, the uplink NAS message may comprise a network slice-specific authentication complete message for the network slice.

In an example, the request message may comprise a first protocol configuration options (PCO) information element. For example, the indication of support for NSSAA over the EPC may be encoded into the PCO information element.

In an example, the PCO information element may comprise a first container identity. For example, the first container identity may be encoded to comprise the indication of support for NSSAA over the EPC.

In an example, the PCO information element may be an extended PCO information element. For example, the extended PCO information element may comprise more information than the PCO information element. For example, the extended PCO information element may have a larger maximum size in bits.

In an example, the indication of support for NSSAA over the EPC may be based on including a GPSI in the request message. For example, the GPSI may be encoded into a first container identity contents field. For example, the first container identity may be encoded to comprise the indication of support for NSSAA over the EPC and the GPSI may be encoded into the first container identity contents. For example, the first container identity contents and the first container identity may be separate fields in the PCO information element.

In an example, the network slice-specific authentication command message may be encoded into a second PCO information element. For example, the second PCO information element may be part of the downlink NAS message.

In an example, the network slice-specific authentication command message may be encoded in a second container identity. For example, the second container identity may be encoded to indicate a second container contents field comprises an EAP-Request message. For example, the second container identity may be encoded with a value corresponding to network slice-specific authentication command message and/or the like. For example, the second container contents field may comprise the EAP-Request message.

In an example, the network slice-specific authentication complete message may be encoded into a third PCO information element. For example, the third PCO information element may be part of the uplink NAS message.

In an example, the network slice-specific authentication complete message may be encoded in a third container identity. For example, the third container identity may be encoded to indicate a third container contents field comprises an EAP-Response message. For example, the third container identity may be encoded with a value corresponding to network slice-specific authentication complete message and/or the like. For example, the third container contents field may comprise the EAP-Response message.

In an example, the UE may receive a second downlink NAS message from the base station. For example, the second downlink NAS message may comprise a network slice-specific authentication result message. For example, the network slice-specific authentication result message may comprise an EAP-Success indication or EAP-Failure indication. For example, the EAP-success indication may inform the UE the NSSAA was successful. For example, the EAP-Failure may indicate the NSSAA was unsuccessful.

In an example, the network slice-specific authentication result may be encoded into a fourth PCO information element. For example, the fourth PCO information element may be part of the second downlink NAS message.

In an example, the network slice-specific authentication result message may be encoded in a fourth container identity. For example, the fourth container identity may be encoded to indicate a fourth container contents field comprises an EAP-Result message. For example, the fourth container identity may be encoded with a value corresponding to network slice-specific authentication result message and/or the like. For example, the fourth container contents field may comprise the EAP-Response message. For example, the EAP-Response message may be a EAP-Success message or a EAP-Failure message.

In an example, the second downlink NAS message may comprise the EAP-Success message and a slice identifier if the network slice. For example, the UE may add the network slice identified by the slice identifier to an allowed NSSAI. For example, the UE may add the network slice to the allowed NSSAI based on receiving the EAP-Success.

In an example, the UE may have disabled N1 mode. For example, the UE may be operating in an area where availability for a 5GC and EPC is scattered and in order to minimize service interruption, the UE may disable N1 mode and operate in S1 mode for compatibility with the EPC.

What is claimed is:

1. A method comprising:
sending, by a wireless device to a base station associated with an evolved packet system (EPS), a request message requesting a packet data network (PDN) connectivity, wherein:
the request message comprises an indication of support for network slice specific authentication and authorization (NSSAA) over the EPS; and
the PDN connectivity is associated with a network slice of a 5G system (5GS).

2. The method of claim 1 wherein the request message comprises a protocol configuration option (PCO) information element (IE) with the indication of support for NSSAA over the EPS.

3. The method of claim 2, wherein the PCO IE comprises a container identifier for the indication of support for NSSAA over the EPS.

4. The method of claim 3, wherein the indication of support for NSSAA over the EPS is encoded into the container identifier.

5. The method of claim 2, wherein the PCO IE is an extended PCO.

6. The method of claim 1, wherein the indication of support for NSSAA over the EPS is based on inclusion of a generic public subscription identifier (GPSI) in the request message.

7. The method of claim 6, wherein the GPSI is encoded into a protocol configuration option (PCO) information element (IE).

8. A wireless device, comprising a processor and memory storing instructions that, when executed by the processor, cause the wireless device to:
send, to a base station associated with an evolved packet system (EPS), a request message requesting a packet data network (PDN) connectivity, wherein:
the request message comprises an indication of support for network slice specific authentication and authorization (NSSAA) over the EPS; and
the PDN connectivity is associated with a network slice of a 5G system (5GS).

9. The wireless device of claim 8 wherein the request message comprises a protocol configuration option (PCO) information element (IE) with the indication of support for NSSAA over the EPS.

10. The wireless device of claim 9, wherein the PCO IE comprises a container identifier for the indication of support for NSSAA over the EPS.

11. The wireless device of claim 10, wherein the indication of support for NSSAA over the EPS is encoded into the container identifier.

12. The wireless device of claim 9, wherein the PCO IE is an extended PCO.

13. The wireless device of claim 8, wherein the indication of support for NSSAA over the EPS is based on inclusion of a generic public subscription identifier (GPSI) in the request message.

14. The wireless device of claim 13, wherein the GPSI is encoded into a protocol configuration option (PCO) information element (IE).

15. A method comprising:
receiving, by a session management function and packet data network gateway control function (SMF+PGW-C) from a service gateway (SGW), a create session request message requesting to establish a packet data network (PDN) connection wherein:
the PDN connection is associated with a network slice of a 5G system (5GS);
the create session request message comprises an indication of support for network slice specific authentication and authorization (NSSAA) over an evolved packet system (EPS);
determining, by the SMF+PGW-C that the network slice requires NSSAA;
sending, by the SMF+PGW-C to a network slice-specific and standalone non-public network (SNPN) authentication and authorization function (NSSAAF) and based on the indication of support for NSSAA over EPS, an authentication request for the network slice;
receiving, by the SMF+PGW-C from the NSSAAF, an authentication message for the network slice; and
sending by the SMF+PGW-C to the SGW, an update bearer request message comprising the authentication request for the network slice.

16. The method of claim 15 wherein the SMF+PGW-C sends the authentication request for the network slice to the NSSAAF via an interface.

17. The method of claim 16, wherein the interface is a service based interface.

18. The method of claim 15, wherein the create session request message comprises a generic public subscription identifier (GPSI).

19. The method of claim 15, wherein the authentication request for the network slice comprises the indication of support for NSSAA over the EPS.

20. The method of claim 15, wherein the update bearer request message comprises a slice identifier associated with the network slice.
